(19) United States
(12) Patent Application Publication
(10) Pub. No.: US 2023/0351285 A1
(43) Pub. Date: Nov. 2, 2023

(54) INFORMATION PROCESSING DEVICE AND INFORMATION PROCESSING METHOD

(71) Applicant: DENSO TEN Limited, Kobe-shi, Hyogo (JP)

(72) Inventors: Shinichi TANAKA, Kobe (JP); Shinichi SHIOTSU, Kobe (JP); Haruki SHIRAISHI, Kobe (JP); Minoru MAEHATA, Kobe (JP); Miki HITOTSUYA, Kobe (JP); Tomohiro IKEDA, Kobe (JP)

(73) Assignee: DENSO TEN Limited, Kobe-shi, Hyogo (JP)

(21) Appl. No.: 18/008,042

(22) PCT Filed: May 24, 2021
(86) PCT No.: PCT/JP2021/019602

§ 371 Date: Dec. 2, 2022

(30) Foreign Application Priority Data
Jul. 17, 2020 (JP) 2020-123085
Jul. 17, 2020 (JP) 2020-123232

(51) Int. Cl. G06Q 10/0631; G08G 1/00

(52) U.S. Cl. CPC G06Q 10/06315; G08G 1/202

(57) ABSTRACT

A problem is to efficiently ease peripheral congestion of an event facility. An information processing device includes an acquisition unit and a setting unit. The acquisition unit acquires retention information indicating a retention situation of persons in an event facility. The setting unit dynamically sets a plurality of stands of moving bodies based on the retention information acquired by the acquisition unit. The acquisition unit acquires stand-by number information that indicates numbers of moving bodies standing by in the plurality of stands set by the setting unit. Based on the stand-by number information acquired by the acquisition unit, the setting unit sets the numbers of moving bodies to be dispatched to the stands such that the numbers of moving bodies standing by in the plurality of stands are equalized.

### FIELD

The embodiments discussed herein are directed to an information processing device and an information processing method.

### BACKGROUND

Conventionally, various technologies have been proposed for easing congestion in a periphery of an event facility at an event such as a concert (see Patent Literature 1, for example). In the conventional technologies, in an operation management system of a bus operation company at an event, a mode of a bus station in an event facility is changed, and special buses are allowed to start from the above-mentioned bus station, so as to reduce persons that wait for a bus.

### CITATION LIST

### Patent Literature

WO 2016/079778

### SUMMARY

### Technical Problem

However, the conventional technology has a room for improvement in efficiently easing congestion in a periphery of an event facility at an event, and reducing occurrence of congestion in a periphery of an event facility at an event.

One aspect of the present disclosure is made in view of the aforementioned, and an object of the embodiments is to provide an information processing device and an information processing method capable of efficiently easing congestion in a periphery of an event facility at an event, and reducing occurrence of congestion in a periphery of an event facility at an event.

### Solution to Problem

An information processing device according to one aspect of embodiments includes an acquisition unit and a setting unit. The acquisition unit acquires retention information indicating a retention situation of persons in an event facility. The setting unit dynamically sets a plurality of stands of moving bodies based on the retention information acquired by the acquisition unit. The acquisition unit acquires stand-by number information that indicates numbers of moving bodies standing by in the plurality of stands set by the setting unit. Based on the stand-by number information acquired by the acquisition unit, the setting unit sets the numbers of moving bodies to be dispatched to the stands such that the numbers of moving bodies standing by in the plurality of stands are equalized.

### Advantageous Effects of Invention

According to the present disclosure, it is possible to efficiently ease congestion in a periphery of an event facility at an event, and to reduce occurrence of congestion in a periphery of an event facility at an event.

### BRIEF DESCRIPTION OF DRAWINGS

FIG. 1 is a diagram illustrating the outline of an information processing method according to a first embodiment.

FIG. 2 is a block diagram illustrating a configuration example of an information processing system according to the first embodiment.

FIG. 3 is a block diagram illustrating a configuration example of an information processing device according to the first embodiment.

FIG. 4 is a diagram illustrating one example of retention information according to the first embodiment.

FIG. 5 is a diagram illustrating one example of user information according to the first embodiment.

FIG. 6 is a diagram illustrating one example of stand information according to the first embodiment.

FIG. 7 is a diagram illustrating one example of vehicle information according to the first embodiment.

FIG. 8 is a diagram illustrating processes to be executed by an acquisition unit and a setting unit according to the first embodiment.

FIG. 9 is a diagram illustrating a display according to the first embodiment.

FIG. 10 is a flowchart illustrating a processing procedure to be executed by the information processing device according to the first embodiment.

FIG. 11 is a diagram illustrating an information processing device according to a modification.

FIG. 12 is a diagram illustrating the outline of an information processing method according to a second embodiment.

FIG. 13 is a block diagram illustrating a configuration example of an information processing system according to the second embodiment.

FIG. 14 is a block diagram illustrating a configuration example of an information processing device according to the second embodiment.

FIG. 15 is a diagram illustrating one example of user information according to the second embodiment.

FIG. 16 is a diagram illustrating one example of facility information according to the second embodiment.

FIG. 17 is a diagram illustrating one example of stand information according to the second embodiment.

FIG. 18 is a diagram illustrating one example of vehicle information according to the second embodiment.

FIG. 19 is a diagram illustrating one example of provision information according to the second embodiment.

FIG. 20 is a diagram illustrating processes to be executed by a setting unit according to the second embodiment.

FIG. 21 is a diagram illustrating a display according to the second embodiment.

FIG. 22 is a flowchart illustrating a processing procedure to be executed by the information processing device according to the second embodiment.

### DESCRIPTION OF EMBODIMENTS

Hereinafter, embodiments of an information processing device and an information processing method disclosed in the present application will be described in detail with reference to the accompanying drawings. Moreover, the present disclosure is not limited to the embodiments described below.

<Outline of Information Processing Method According to First Embodiment>

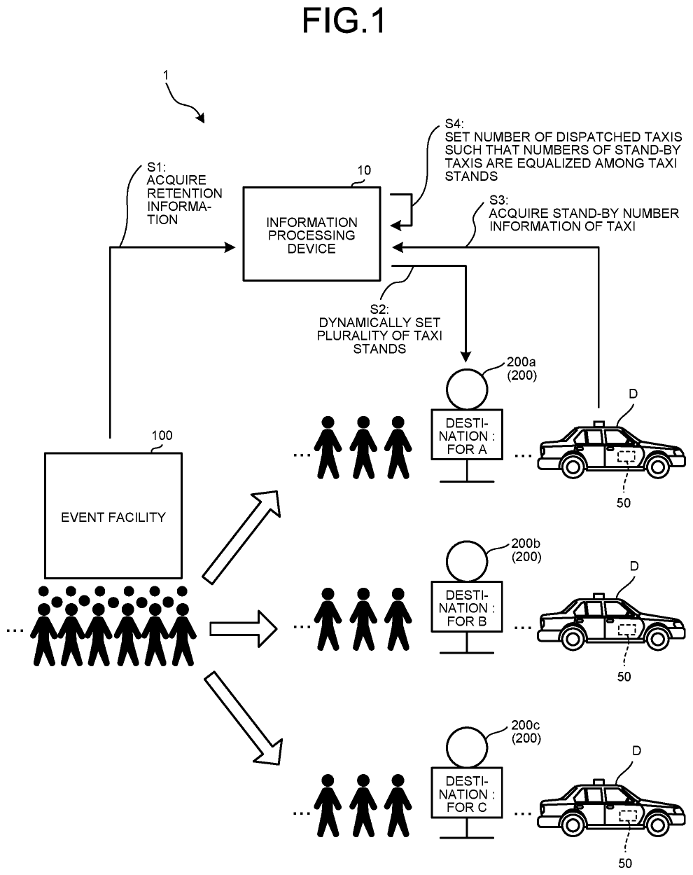

Hereinafter, the outline of an information processing method according to a first embodiment will be explained with reference to FIG. 1. FIG. 1 is a diagram illustrating the outline of the information processing method according to the first embodiment.

As illustrated in FIG. 1, an information processing method according to the first embodiment is executed by an information processing device 10 that is included in an information processing system 1, for example. The information processing device 10 is a server that is capable of executing various processes such as processing on information related to an event facility 100 and processing on information related to a periphery of the event facility 100. Herein, the event facility 100 is, for example, a sports facility in which an event such as a sports game is held, or a building (venue) in which an event such as a concert and a play is held.

In the event facility 100 (hereinafter, may be referred to as “facility 100”), for example, when an event ends, users having used the facility 100, in other words, audiences exit at the same time, and thus a periphery of the facility 100 congests therewith. When a periphery of the facility 100 congests, a time interval for a user to move to a stand of a taxi or a bus on the way home, or the nearest station becomes long; furthermore, even when a user arrives at a taxi stand or the like, a long time interval is necessary until he/her rides a taxi or the like due to congestion in some cases.

Thus, the information processing device 10 according to the present embodiment is configured to efficiently ease a peripheral congestion of the facility 100.

Hereinafter, processing of the information processing device 10 will be specifically explained, and the information processing device 10 first acquires retention information that indicates a retention situation of persons (users (audiences)) in the facility 100 (Step S1).

As the retention information, information on the number of retained persons in a periphery of the facility 100 (retained headcount) may be used; however, not limited thereto. For example, retention information may include flow-of-persons information that indicates a flow of persons in a periphery of the facility 100, such as a moving speed of persons, information on a congestion degree in a periphery of the facility 100, or the like. Note that the congestion degree is an index value that indicates an extent of a congestion situation in a periphery of the facility 100, and is a value that is indicated from among several-step levels according to retained headcount in a periphery of the facility 100, for example.

For example, the retention information includes pieces of information on respective predetermined regions in the facility 100 and a periphery of the facility 100. Specifically, for example, the retention information includes pieces of information on respective divided regions Q2 (see FIG. 8) set by dividing a region Q1 (see FIG. 8) including the facility 100 and a periphery of the facility 100, this point will be mentioned later.

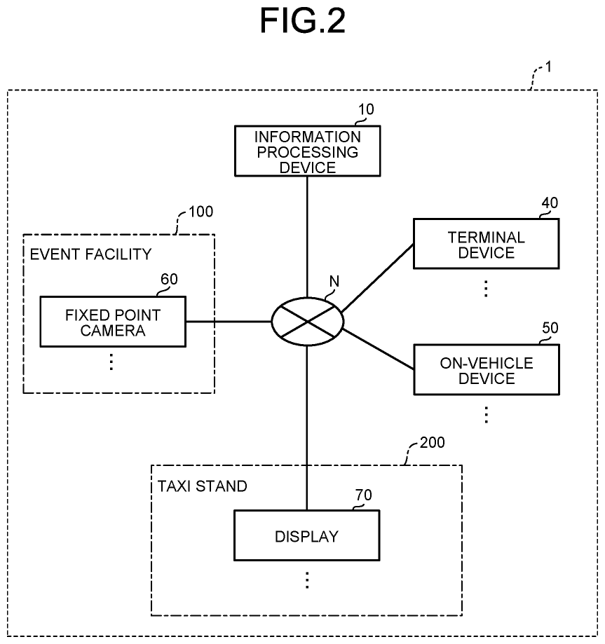

Note that the information processing device 10 acquires the above-mentioned retention information on the basis of, for example, position information of a terminal device 40 (see FIG. 2) that is carried by a user in a periphery of the facility 100, a camera image of a fixed point camera 60 (see FIG. 2) provided in a periphery of the facility 100, and the like; this point will be mentioned later.

Next, the information processing device 10 dynamically sets a plurality of stands 200 of taxis D on the basis of the acquired retention information (Step S2). Hereinafter, the stand 200 of the taxi D may be referred to as “taxi stand 200”.

Herein, a position in which the above-mentioned taxi stand 200 is set is a position that is not a taxi stand in a periphery of the facility 100, in other words, does not function as a taxi stand, when an event is not held in the facility 100 or before an event ends, for example. In other words, the taxi stand 200 is a stand that is virtually set in a periphery of the facility 100, and that is newly set after an event ends, for example.

A position in which the taxi stand 200 is set may be a periphery of the facility 100, or may be a position that is far from the facility 100 to some extent, for example. In FIG. 1, an example is indicated in which the number of the taxi stands 200 is three; however, not limited thereto, the number of the taxi stands 200 may be two or equal to or more four. Hereinafter, the three taxi stands 200 may be referred to as “first taxi stand 200a”, “second taxi stand 200b”, and “third taxi stand 200c”; however, in a case where they are collectively explained, may be simply referred to as “taxi stands 200”.

The taxi stand 200 may be set for each destination of the taxi D, for example. For one example, a destination of the first taxi stand 200a is set to “for A”, a destination of the second taxi stand 200b is set to “for B”, and a destination of the third taxi stand 200c is set to “for C”. The above-mentioned A, B, and C include specific geographical names, specific regional names, and the like. Details of the above-mentioned setting of the taxi stands 200 will be mentioned later.

Note that the taxi D is one example of a moving body. The above-mentioned moving body is not limited to the taxi D, and may be another kind of transportation such as a bus. Thus, for example, in a case where a moving body is a bus, the information processing device 10 sets a stand of bus on the basis of retention information.

When the above-mentioned taxi stand 200 is set, the information processing device 10 may inform an on-vehicle device 50 provided in the taxi D of position information on the taxi stand 200 and the like, for example. Thus, the taxi D is able to arrive at the taxi stand 200 and stand by therein.

As described above, the plurality of virtual taxi stands 200 is dynamically set, and thus as indicated by using open arrows, users (audiences) retained in a periphery of the facility 100 dispersively move to the first to third taxi stands 200a to 200c. Thus, in the present embodiment, it is possible to ease a peripheral congestion of the facility 100.

Next, the information processing device 10 acquires stand-by number information that indicates the number of the stand-by taxis D in each of the plurality of taxi stands 200 (Step S3). The information processing device 10 is capable of acquiring the above-mentioned stand-by number information on the basis of vehicle position information acquired from the on-vehicle devices 50 provided in the taxis D, for example; this point will be mentioned later.

Next, on the basis of the stand-by number information, the information processing device 10 sets the number of the taxis D to be dispatched to the taxi stand 200 such that the numbers of the stand-by taxis D are equalized among the plurality of taxi stands 200 (Step S4). Thus, in the present embodiment, it is possible to efficiently ease peripheral congestion in the event facility 100.

Specifically, for example, if a stand-by number of the first taxi stand 200a is comparatively small and further a stand-by number of the second taxi stand 200b is comparatively large, namely, excessive unevenness occurs among stand-by numbers of the taxis D, persons are retained in the first taxi stand 200a, and as a result, there presents possibility that peripheral congestion in the event facility 100 is hardly eased.

Therefore, the information processing device 10 sets the numbers of allocated vehicles of the taxis D to the taxi stands 200 such that the numbers of the stand-by the taxis D are equalized among the plurality of taxi stands 200. In other words, the information processing device 10 sets the numbers of allocated vehicles to the taxi stands 200 such that stand-by numbers of the taxis D in the taxi stands 200 are equal to each other, namely, the stand-by numbers are equalized, for example. Thus, in the present embodiment, it is possible to reduce occurrence of retention of persons in the taxi stands 200, and further to efficiently ease peripheral congestion in the event facility 100.

In the above-mentioned, “equalization of numbers of stand-by taxis D” means that the stand-by numbers of the taxis D in the taxi stands 200 are approximately equal to each other; however, not limited thereto. For example, the “equalization of numbers of stand-by taxis D” may mean that a time interval until a person having arrived at the taxi stand 200 gets in the taxi D, in other words, a waiting time interval is equal for each of the taxi stands 200.

Specifically, the number of allocated vehicles to the taxi stand 200 may be set such that the number of the stand-by taxis D is larger as the number of persons waiting in line in the taxi stand 200 is larger so as to equalize waiting time intervals among the taxi stands 200, in other words, “equalization of numbers of stand-by taxis D” may be executed among the taxi stand 200. According to the above-mentioned configuration, it is also possible to efficiently ease peripheral congestion in the event facility 100.

<Configuration of Information Processing System According to First Embodiment>

Next, a configuration of the information processing system 1 including the information processing device 10 according to the first embodiment will be explained with reference to FIG. 2. FIG. 2 is a block diagram illustrating a configuration example of the information processing system 1 according to the first embodiment.

As illustrated in FIG. 2, the information processing system 1 includes the above-mentioned information processing device 10, the terminal device 40, the on-vehicle device 50, the fixed point camera 60, and a display 70, which are connected to be able to communicate with each other via a communication network N such as the Internet network. In FIG. 2, for convenience of explanation, the single terminal device 40, the single on-vehicle device 50, the single fixed point camera 60, and the single display 70 are indicated; however any of them may be plural.

The terminal device 40 is a device that is carried and used by a user (audience) of the facility 100. Hereinafter, a person that uses the terminal device 40 may be referred to as “user”. As the terminal device 40, for example, a smartphone, a tablet terminal, or the like may be employed; however, not limited thereto.

The terminal device 40 includes a Global Positioning System (GPS) reception device that detects, on the basis of a signal transmitted from a GPS satellite, user position information indicating a position of a user (precisely, position of terminal device 40). The terminal device 40 is capable of transmitting the detected user position information to the information processing device 10.

The terminal device 40 is capable of executing a process for making a reservation for a taxi. For example, a destination, the number of passengers to board, and the like is input to the terminal device 40 by an operation of a user, and the terminal device 40 transmits them to the information processing device 10 as reservation information. Note that a destination included in the reservation information may be information that indicates a direction such as “for A”, or may be information on a specific alighting position. The reservation information may include information for making a reservation alone without including information on a destination or the number of passengers to board. In a case where receiving reservation information from the terminal device 40, the information processing device 10 executes a process for receiving a reservation, and this point will be mentioned later.

The above-mentioned reservation process is executed by an application (hereinafter, application) that is registered in the terminal device 40, for example; however, not limited thereto. In other words, for example, a reservation process may be executed via a taxi reservation site that is delivered from a not-illustrated external device (external server) to the terminal device 40, and reservation information may be transmitted from the external device to the information processing device 10, namely, the reservation process may be executed by another method.

As described above, the on-vehicle device 50 is a device that is provided in a taxi. For example, the on-vehicle device 50 includes a GPS reception device so as to detect, on the basis of a signal transmitted from a GPS satellite, vehicle position information that indicates a position of a taxi. The on-vehicle device 50 is capable of transmitting the detected vehicle position information to the information processing device 10.

In addition to the above-mentioned vehicle position information, the on-vehicle device 50 is capable of transmitting operation state information that indicates an operation state of a taxi to the information processing device 10. The operation state of a taxi means a state (dynamic state) of a taxi, such as “vacant” and “in service”. Note that in the on-vehicle device 50, switching between “vacant” and “in service” is executed by an operation of a driver.

The on-vehicle device 50 is capable of receiving a dispatch instruction (to be mentioned later) that is transmitted from the information processing device 10. Herein, a dispatch instruction is a dispatch instruction for the taxi stand 200. In a case where the on-vehicle device 50 receives a dispatch instruction, a taxi moves toward the taxi stand 200, and picks up a passenger in the taxi stand 200. Note that the dispatch instruction may include a route of a taxi that moves for the taxi stand 200, for example. In this case, a taxi moves for the taxi stand 200 via a route included in a dispatch instruction.

The fixed point camera 60 captures a periphery of the facility 100. For example, the fixed point camera 60 is arranged in a position through which a user (audience) of the facility 100 is able to go, such as an entrance of the facility 100 and a peripheral pavement of the facility 100.

The fixed point camera 60 is capable of capturing a periphery of the facility 100, such as an entrance of the facility 100, and further transmitting the captured camera image to the information processing device 10. A camera image of the fixed point camera 60 is video data; however, not limited thereto, may be static image data. The camera image is acquired as retention information in the information processing device 10, and this point will be mentioned later.

The fixed point camera 60 may be a human detecting sensor that detects a person in a periphery of the facility 100. For the human detecting sensor, for example, a pyroelectric sensor using an infrared ray signal, etc. may be employed.

As described above, in a case where the information processing device 10 acquires retention information on the basis of position information of the terminal device 40, in other words, in a case where a camera image of the fixed point camera 60 is not used as retention information, the fixed point camera 60 may be omitted.

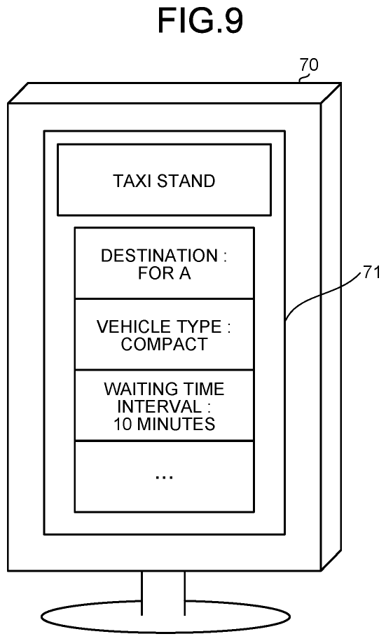

The display 70 is configured to be arranged in the taxi stand 200, and for example, and displays information related to the taxi stand 200, such as a destination. For example, a digital signage may be used as the display 70, and displays various kinds of information that is delivered from the information processing device 10 or the like via the communication network N. The display 70 will be mentioned later with reference to FIG. 9.

<Configuration of Information Processing Device According to First Embodiment>

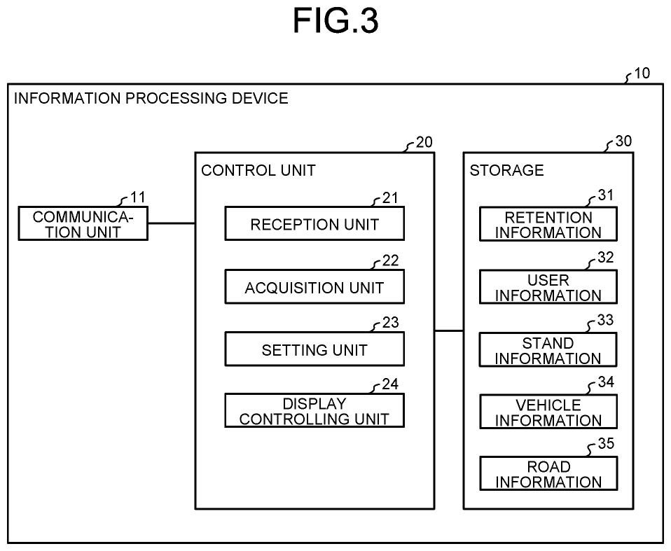

Next, details of a configuration of the information processing device 10 according to the first embodiment will be explained with reference to FIG. 3 and the like. FIG. 3 is a block diagram illustrating a configuration example of the information processing device 10 according to the first embodiment. Note that in block diagrams illustrated in FIG. 3 and the like, configuration elements needed for explaining features of the embodiment alone are indicated by using functional blocks, and description of general configuration elements is omitted.

In other words, the configuration elements in the block diagrams illustrated in FIG. 3 and the like are functionally conceptual, and thus they are not to be physically configured as illustrated in the drawings. Specific forms of distribution and integration of the configuration elements of the illustrated devices are not limited to those illustrated in the drawings, and all or some of the devices can be configured by separating or integrating the apparatus functionally or physically in any unit, according to various types of loads, the status of use, etc.

As illustrated in FIG. 3, the information processing device 10 includes a communication unit 11, a control unit 20, and a storage 30.

The communication unit 11 is a communication interface connected to the communication network N to be able to communicate with each other, and transmits and receives information to and from the terminal device 40, the on-vehicle device 50, the fixed point camera 60, the display 70, and the like.

The control unit 20 includes a reception unit 21, an acquisition unit 22, a setting unit 23, and a display controlling unit 24, and further includes a computer including, for example, a Central Processing Unit (CPU), a Read Only Memory (ROM), a Random Access Memory (RAM), a hard disc drive, an input/output port, and the like; and various circuits.

A CPU of the computer reads and executes a program stored in a ROM, for example, so as to function as the reception unit 21, the acquisition unit 22, the setting unit 23, and the display controlling unit 24 of the control unit 20.

At least a part or all of the reception unit 21, the acquisition unit 22, the setting unit 23, and the display controlling unit 24 of the control unit 20 may be constituted of hardware such as an Application Specific Integrated Circuit (ASIC) and a Field Programmable Gate Array (FPGA).

The storage 30 is a storage that is constituted of a storage device such as a non-volatile memory, a data flash, and a hard disc drive. The above-mentioned storage 30 stores therein retention information 31, user information 32, stand information 33, vehicle information 34, road information 35, and various programs.

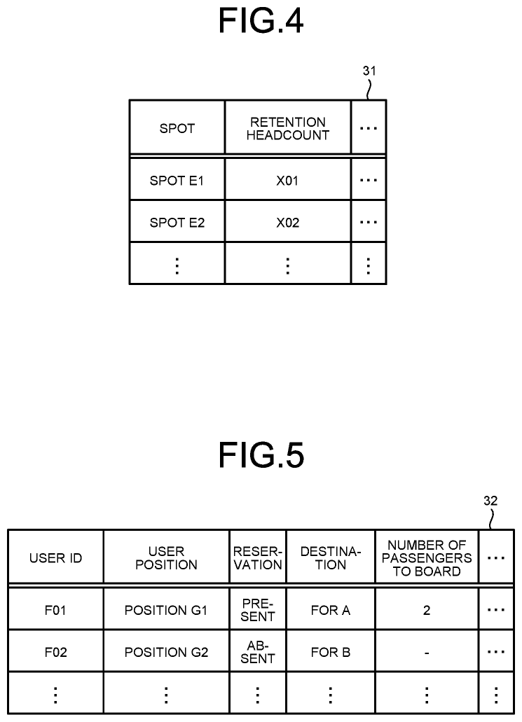

The retention information 31 is information that indicates a retention situation of persons in the facility 100. Herein, the retention information 31 will be explained with reference to FIG. 4. FIG. 4 is a diagram illustrating one example of the retention information 31 according to the first embodiment.

As illustrated in FIG. 4, the retention information 31 includes items such as “spot” and “retention headcount”, and the items are associated with each other. The “spot” is information that indicates a spot of the facility 100 and a periphery of the facility 100, and specifically, information for identifying the divided regions Q2 (see FIG. 8) to be mentioned later, information that indicates an appellation of an entrance of the facility 100 such as an east exit and a west exit, a pavement in a periphery of the facility 100, and the like.

In the example illustrated in FIG. 4, for convenience of explanation, “spot” may be abstractly referred to as “spot E1”, the “spot E1” stores therein specific information. Hereinafter, other pieces of information may be abstractly referred.

The “retention headcount” is information that indicates the number of persons retained in the above-mentioned spot in the periphery of the facility 100. In addition to “retention headcount” or instead thereof, the retention information 31 may include flow-of-persons information that indicates a flow of persons in a periphery of the facility 100 such as a moving speed of the above-mentioned persons, information on a congestion degree in a periphery of the facility 100, and the like.

The example illustrated in FIG. 4 indicates that a retention headcount is “X01” in “spot E1” in a periphery of the facility 100.

Returning to FIG. 3, the user information 32 is information related to a user. Herein, the user information 32 will be explained with reference to FIG. 5. FIG. 5 is a diagram illustrating one example of the user information 32 according to the first embodiment.

As illustrated in FIG. 5, the user information 32 includes items such as “user ID”, “user position”, “reservation”, “destination”, and “number of passengers to board”, and the items are associated with each other.

The “user ID” is identification information identifying a user that uses the terminal device 40. The “user position” is user position information that indicates a position of a user. The “reservation” is information that indicates presence/absence of a reservation for a taxi.

The “destination” is information that indicates a destination of a user from the facility 100. For example, the “destination” is information that indicates a destination of a user after an event ends in the facility 100. Specifically, information on a destination included in reservation information that is transmitted from the terminal device 40 is registered in the “destination”.

In a case where reservation information does not include information on a destination, or in a case where there presents no reservation, a destination is estimated from other information, and information on the estimated destination may be registered in “destination”. In other words, for example, when an event ends, a user often returns to his/her home via a route reverse to a route to the facility 100, or often returns to his/her home from the facility 100. Thus, for example, the acquisition unit 22 (see FIG. 3) of the control unit 20 acquires behavior history information (specifically, information on route to facility 100) and home information of a user, and the like from the terminal device 40, and estimates a destination of the user after an event ends on the basis of the above-mentioned behavior history information, the above-mentioned home information, and the like. The acquisition unit 22 is capable of registering information on the estimated destination as “destination” of the user information 32.

The “number of passengers to board” is information that indicates the number of persons that are going to board (ride) taxis. Specifically, in a case where reservation information transmitted from the terminal device 40 includes the number of passengers to board, information on the above-mentioned number of passengers to board is registered in the “number of passengers to board”.

In the example illustrated in FIG. 5, data of a user whose user ID is identified by “F01” indicates that a user position is “position G1”, a reservation is “present”, a destination is “for A”, and the number of passengers to board is “two”.

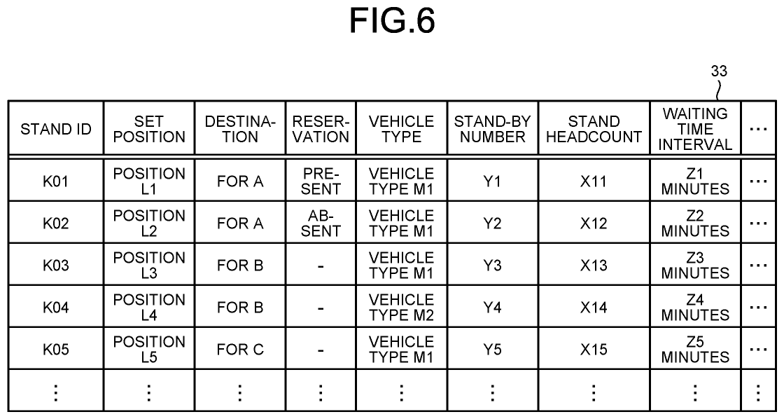

Returning to FIG. 3, the stand information 33 is information related to the taxi stand 200. Herein, the stand information 33 will be explained with reference to FIG. 6. FIG. 6 is a diagram illustrating one example of the stand information 33 according to the first embodiment.

As illustrated in FIG. 6, the stand information 33 includes items of “stand ID”, “set position”, “destination”, “reservation”, “vehicle type”, “stand-by number”, “stand headcount”, “waiting time interval”, and the like; and the items are associated with each other.

The “stand ID” is identification information that identifies the taxi stand 200. The “set position” is position information that indicates a position of the set taxi stand 200. The “destination” is information that indicates a destination of a taxi in the taxi stand 200.

The “reservation” is information that indicates presence/absence of a reservation, which is a condition for using a taxi of the taxi stand 200. In other words, “present” of “reservation” in the stand information 33 indicates the taxi stand 200 to be used by a person having made a reservation for a taxi via the terminal device 40 or the like, and “absence” indicates the taxi stand 200 to be used by a person not having made a reservation for a taxi. In a case where presence/absence of a reservation is not set as a use condition, the information is not registered in “reservation” of the stand information 33.

The “vehicle type” is information that indicates a vehicle type of a taxi to be dispatched to the taxi stand 200. The “vehicle type” is also information that indicates a vehicle type of a taxi that stands by in the taxi stand 200. The “vehicle type” includes information that indicates classification according to a size of a vehicle such as a compact vehicle, a medium-sized vehicle, and a large-sized vehicle, in other words, information that indicates classification according to a riding capacity; however, not limited thereto.

The “stand-by number” is information that indicates the number of presently-stand-by taxis in the taxi stand 200. The above-mentioned “stand-by taxi in taxi stand 200” is not limited to a taxi that actually stands by in the taxi stand 200, and may include a taxi that is moving to the taxi stand 200 by a dispatch instruction, for example. For one example, “stand-by taxi in taxi stand 200” may include a taxi that satisfies a temporal condition, for example, it will arrive at the taxi stand 200 within five minutes.

The “stand headcount” is information that indicates the number of persons that are presently waiting in line in the taxi stand 200. The above-mentioned “persons that are presently waiting in line in taxi stand 200” are not limited to persons that are actually waiting in line in taxi stand 200, which are estimated by user position information or the like, and may include persons that are moving to the taxi stand 200 and that are going to move to the taxi stand 200, which are estimated on the basis of reservation information, for example.

The “waiting time interval” is information that indicates a time interval until a person having arrived at the corresponding taxi stand 200 gets in a taxi.

In the example illustrated in FIG. 6, data on the taxi stand 200 that is identified by a stand ID “K01” indicates that a set position is “position L1”, a destination is “for A”, a reservation is “present”, a vehicle type is “vehicle type M1”, a stand-by number is “Y1”, a stand headcount is “X11”, a waiting time interval is “Z1 minutes”.

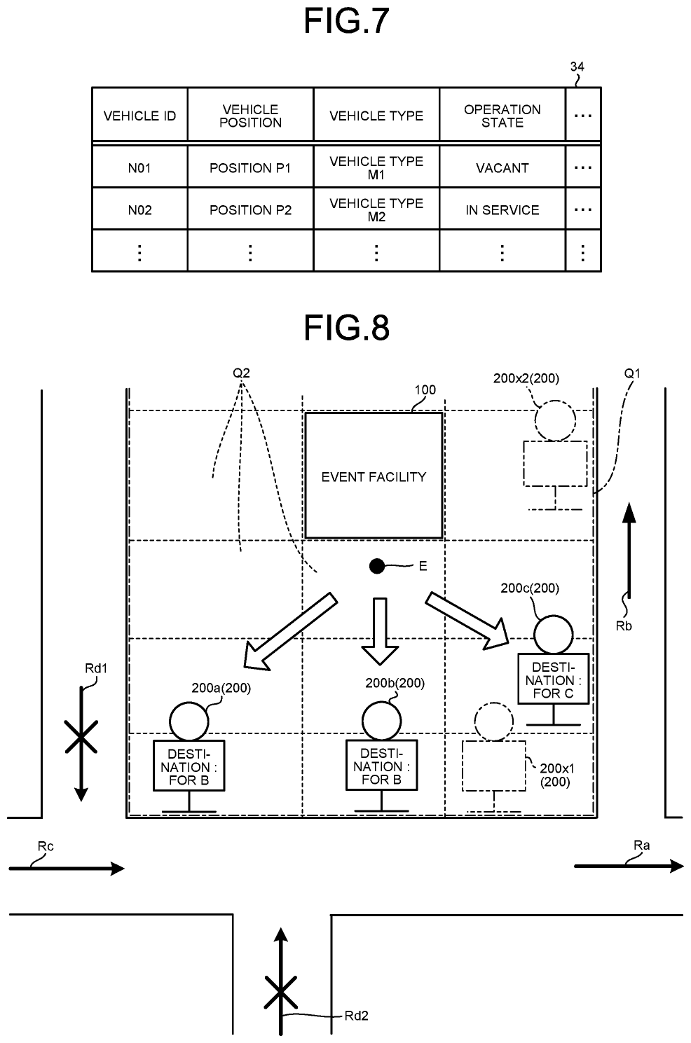

Returning to FIG. 3, the vehicle information 34 is information related to a taxi (moving body). Herein, with reference to FIG. 7, the vehicle information 34 will be explained. FIG. 7 is a diagram illustrating one example of the vehicle information 34 according to the first embodiment.

As illustrated in FIG. 7, the vehicle information 34 includes items such as “vehicle ID”, “vehicle position”, “vehicle type”, and “operation state”, and the items are associated with each other.

The “vehicle ID” is identification information for identifying a taxi. The “vehicle position” is vehicle position information that indicates a position of a taxi. The “vehicle type” is information that indicates a vehicle type of a taxi. As described above, the “vehicle type” includes information that indicates classification according to a size of a vehicle such as a compact vehicle, a medium-sized vehicle, and a large-sized vehicle; however, not limited thereto. The “operation state” is operation-state information that indicates an operation state of a taxi.

In the example indicated in FIG. 7, data on a taxi that is identified by a vehicle ID “N01” indicates that a vehicle position is “position P1”, a vehicle type is “vehicle type M1”, and an operation state is “vacant”.

Returning to FIG. 3, the road information 35 is information related to a road in a periphery of the facility 100. The road information 35 includes, for example, map information including roads in a periphery of the facility 100, and congestion information and construction information in roads in a periphery of the facility 100; however, not limited thereto. Note that the congestion information is not limited to present congestion information, and may be estimated congestion information.

The reception unit 21 of the control unit 20 receives reservation information of a taxi from the terminal device 40 via the communication unit 11 so as to execute a process for receiving a reservation. For example, the reception unit 21 registers information on a destination included in reservation information, the number of passengers to board, and the like into the user information 32 (see FIG. 5). The reception unit 21 is capable of informing the terminal device 40 of a content indicating the fact that a reservation has been received.

In a case where a reservation process of a taxi is executed in the terminal device 40 via a taxi reservation site, the reception unit 21 may receive reservation information from an external device that delivers a taxi reservation site, so as to execute a process for receiving a reservation.

The acquisition unit 22 acquires retention information that indicates a retention situation of persons in the facility 100. Retention information acquired by the acquisition unit 22 and the like will be explained with reference to FIG. 8. FIG. 8 is a diagram illustrating processes to be executed by the acquisition unit 22 and the setting unit 23 according to the first embodiment.

As illustrated in FIG. 8 by using dashed lines, “region Q1” including the facility 100 and a periphery of the facility 100 is managed by the information processing device 10. The above-mentioned region (management region) Q1 is divided as indicated by using dashed lines, and the plurality of divided regions Q2 is set. Note that the number and shapes of the divided regions Q2 illustrated in FIG. 8 are merely examples and not limited thereto, and may be arbitrary ones.

For example, the divided regions Q2 may be set for each entrance of the facility 100. Specifically, for example, the acquisition unit 22 acquires, from an external server, information that indicates a distribution situation of persons in the facility 100 as a parameter of a congestion situation. Information that indicates the above-mentioned distribution situation is distribution information of persons in the facility 100 corresponding to an entrance, and is information that is estimated on the basis of, for example, an image captured by a camera provided in the facility 100, information on a reserved seat in a ticket of an event, or the like. The divided regions Q2 may be set for each entrance of the facility 100 in which congestion is estimated on the basis of information that indicates a distribution situation, for example.

For each of the divided regions Q2, the above-mentioned acquisition unit 22 is capable of acquiring retention information that indicates a corresponding retention situation of persons, for example. For example, on the basis of position information of the terminal device 40, the acquisition unit 22 measures the number of persons retained in each spot of a periphery of the facility 100 (for example, divided regions Q2, entrance of facility 100, pavement, and the like), and registers the measured headcount in the retention information 31 (see FIG. 4) of the storage 30. The acquisition unit 22 may register position information of the terminal device 40 as user position information of the user information 32.

Continuing explanation of FIG. 3, the acquisition unit 22 may acquire retention information on the basis of a camera image captured by the fixed point camera 60 (see FIG. 2) and the like. For example, the acquisition unit 22 may analyze a camera image transmitted from the fixed point camera 60 so as to measure the number of persons retained in each spot of a periphery of the facility 100, and may register it in the retention information 31.

The acquisition unit 22 acquires information on a stand headcount of the taxi stand 200. For example, on the basis of position information (in other words, user position information) of the terminal device 40, the acquisition unit 22 measures the number of persons waiting in line in the taxi stand 200, and registers the measured headcount in the stand information 33 (see FIG. 6) of the storage 30.

The acquisition unit 22 acquires vehicle position information, operation-state information, or the like transmitted from the on-vehicle device 50, and registers the acquired vehicle position information and the like in the vehicle information 34 (see FIG. 7) of the storage 30.

The acquisition unit 22 acquires stand-by number information that indicates the number of taxis that stand by in each of the plurality of taxi stands 200. For example, on the basis of vehicle position information transmitted from the on-vehicle device 50, the acquisition unit 22 measures the number of taxis that stand by in each of the plurality of taxi stands 200, and registers the measured number of taxis, in other words, a stand-by number in the stand information 33 (see FIG. 6) in the storage 30.

For one example, in a case where vehicle position information transmitted from the on-vehicle device 50 is within a predetermined range including a position of the first taxi stand 200a (see FIG. 1), the acquisition unit 22 estimates that a taxi provided with the above-mentioned on-vehicle device 50 stands by in the first taxi stand 200a so as to acquire, as stand-by number information, the number of taxis estimated to stand by.

The above-mentioned predetermined range is set to be a range in which the taxi D is estimated to stand by in the corresponding taxi stand 200, not limited thereto, may be set to an appropriate arbitrary condition (for example, as described above, taxi that satisfies temporal condition, for example, it will arrive at taxi stand 200 within five minutes). The acquisition unit 22 may acquire the stand-by number information by another method, for example, may acquire from an external device such as a management server (not illustrated) that manages taxis.

The acquisition unit 22 acquires road information related to a road in a periphery of the facility 100, and stores it in the storage 30 as the road information 35. Note that the road information is transmitted from an external server, for example.

The setting unit 23 reads out the retention information 31 of the storage 30, and dynamically sets the plurality of taxi stands 200 on the basis of the read retention information 31. In other words, the setting unit 23 sets the plurality of dynamic taxi stands 200 whose positions and number are changed on the basis of the retention information 31. Herein, setting of the taxi stands 200 and the like will be explained with reference to FIG. 8.

As illustrated in FIG. 8, for example, the setting unit 23 dynamically sets the plurality of taxi stands 200 in accordance with retention information of each of the divided regions Q2. Specifically, in a case where retention information includes information indicating the fact that many persons are retained in a spot E in a periphery of the building (event facility) 100, the setting unit 23 dynamically sets the plurality of taxi stands 200 (herein, first to third taxi stands 200a to 200c) in order to ease congestion in the spot E.

For one example of setting by the taxi stand 200, the setting unit 23 selects, on the basis of retention information, a position capable of easing congestion in the spot E from among a plurality of predetermined-set candidate stands, and sets the selected candidate stand as the taxi stand 200. The setting unit 23 registers various kinds of information related to the taxi stand 200, such as a set position of the taxi stand 200, in the stand information 33 (see FIG. 6) of the storage 30.

After setting the taxi stand 200, the setting unit 23 may execute a dispatch process for informing the on-vehicle device 50 provided in a taxi of position information of the taxi stand 200 and the like. For example, the setting unit 23 may reads out the vehicle information 34 of the storage 30 so as to transmit a dispatch instruction such that a taxi whose operation state is vacant goes to the taxi stand 200.

As described above, the setting unit 23 dynamically sets the plurality of virtual taxi stands 200, and thus persons retained in the spot E dispersively move to the first to the third taxi stands 200a to 200c as indicated by using open arrows. Thus, it is possible to ease congestion in the spot E that is a periphery of the facility 100.

Retention information of each of the divided regions Q2 changes in accordance with passage of time and the like. Thus, as indicated by imaginary lines illustrated in FIG. 8, the setting unit 23 may add or reduce the taxi stand 200 in accordance with change in retention information of each of the divided regions Q2 so as to increase or reduce the number of the taxi stands 200, and may change a destination set for the taxi stand 200. In the example illustrated in FIG. 8, a taxi stand 200x1 indicates the taxi stand 200 that is deleted after being set by the setting unit 23 once, and a taxi stand 200x2 indicates the taxi stand 200 that is newly added by the setting unit 23. Thus, it is possible to efficiently ease a peripheral congestion of the facility 100 in accordance with change in retention information of each of the divided regions Q2.

The setting unit 23 reads out the stand information 33 of the storage 30, and on the basis of stand-by number information included in the stand information 33 and the like, sets the number of taxis dispatched to the taxi stand 200 so as to equalize the numbers of taxis that stand by in the plurality of taxi stands 200.

For example, in a case where stand-by number information includes information in which excessive unevenness occurs between the taxi stands 200, for example, a stand-by number of the first taxi stand 200a is excessively smaller than a stand-by number of the other taxi stand 200 (herein, second or third taxi stand 200b or 200c), the setting unit 23 executes setting so as to increase the number of taxis to be dispatched to the first taxi stand 200a. Thus, the numbers of taxis that stand by in the taxi stands 200 are equalized, and thus persons are hardly retained in the first taxi stand 200a, so that it is possible to efficiently ease congestion in the spot E that is a periphery of the facility 100.

On the basis of stand-by number information, stand headcount information, waiting time interval information, and the like, the setting unit 23 may set the number of taxis to be dispatched to the taxi stand 200. For example, in a case where a stand headcount of the first taxi stand 200a is larger than a stand headcount of the other taxi stand 200 or in a case where a waiting time interval of the first taxi stand 200a is longer than a waiting time interval of the other taxi stand 200, and further in a case where a stand-by number of the first taxi stand 200a is comparatively small, the setting unit 23 may execute setting so as to increase the number of taxis to be dispatched to the first taxi stand 200a. Thus, stand-by numbers of taxis are equalized so as to equalize a stand headcount and a waiting time interval among the taxi stands 200, and thus persons are hardly retained in the first taxi stand 200a, so that it is possible to efficiently ease congestion in the spot E that is a periphery of the facility 100.

The setting unit 23 may set the number of taxis to be dispatched to the taxi stand 200 in accordance with retention information of each of the divided regions Q2. For example, the setting unit 23 may set the number of taxis to be dispatched to the taxi stand 200 in accordance with the number of persons included in retention information of each of the divided regions Q2. For one example, in a case where retention information of each of the divided regions Q2 includes information indicating the fact that many persons are retained, the setting unit 23 may execute setting so as to increase the number of taxis to be dispatched to the taxi stand 200. Thus, it is possible to efficiently ease a peripheral congestion of the facility 100 in accordance with retention information of each of the divided regions Q2.

Note that in the above-mentioned, the setting unit 23 sets the taxi stand 200 and sets the number of taxis to be dispatched to the taxi stand 200 in accordance with retention information of each of the divided regions Q2, not limited thereto, may be configured to execute one of the above mentioned settings. In other words, the setting unit 23 executes at least one of the setting of the taxi stand 200 and the setting of the number of taxis to be dispatched to the taxi stand 200 in accordance with retention information of each of the divided regions Q2.

The setting unit 23 may set the taxi stand 200 for each destination of a taxi. In the example illustrated in FIG. 8, the taxi stands 200 are set depending on respective destinations such as destinations of “for A”, “for B”, and “for C”.

Thus, for example, persons retained in the spot E dispersively move to first to the third the taxi stands 200a to 200c depending on destinations thereof. In the taxi stand 200, after a passenger gets in, it is sufficient that a taxi starts toward a corresponding destination, so that it is possible to realize smooth riding in the taxi stand 200. As described above, persons are hardly retained in the taxi stand 200, so that it is possible to efficiently ease congestion in the spot E that is a periphery of the facility 100.

In a case where setting the taxi stand 200 depending on a destination, the setting unit 23 sets the taxi stand 200 to a position in which a destination of the taxi stand 200 corresponds to a destination of a road. In the example illustrated in FIG. 8, in a case where destinations of “for A” and “for B” correspond to a road for a destination Ra, for example, in other words, in a case where a taxi goes “for A” and “for B” via a road for the destination Ra, the first and the second taxi stands 200a and 200b whose destinations are “for A” and “for B” are set along a road for the destination Ra. Similarly, for example, in a case where a destination of “for C” corresponds to a road for a destination Rb, the third taxi stand 200c whose destination is “for C” is set along a road for the destination Rb.

Thus, in the taxi stand 200, a taxi is capable of directly moving to a corresponding destination after it started, so that it is possible to realize smooth riding in the taxi stand 200. Thus, persons are hardly retained in the taxi stand 200, so that it is possible to efficiently ease congestion in the spot E that is a periphery of the facility 100.

The setting unit 23 may increase or reduce the number of the taxi stands 200 in accordance with the number of persons that wish to board, for each destination. For example, on the basis of information on a destination, the number of passengers to board, or the like that are included in the user information 32 (see FIG. 5), the setting unit 23 may set the number of the taxi stands 200 so as to increase the number of the taxi stands 200 having a destination to which persons wishing to board are comparatively many, on the other hand, reduce the number of the taxi stands 200 having a destination to which persons wishing to board are comparatively few. Note that in FIG. 6, the example is indicated in which the number of the taxi stands 200 whose destination is each of “for A” and “for B” is set to two, and the number of the taxi stands 200 whose destination is “for C” is set to one.

As described above, the number of the taxi stands 200 is set in accordance with the number of persons wishing to board, and thus persons retained in the spot E are appropriately dispersed, so that it is possible to further efficiently ease congestion in the spot E that is a periphery of the facility 100.

The setting unit 23 may integrate the taxi stands 200 with each other or may disperse the taxi stands 200 in accordance with the number of persons wishing to board for each destination. For one example, in a case where the number of persons wishing to board with respect to destinations of “for A” and “for B” becomes small, the setting unit 23 may integrate the first taxi stand 200a whose destination is “for A” and the second taxi stand 200b whose destination is “for B” so as to set the taxi stand 200 whose destination is single one of “for A and B”. In this case, the setting unit 23 may integrate the taxi stands 200 (herein, first and second taxi stands 200a and 200b) that are set to a road for the same destination Ra.

Similarly, in a case where the number of persons wishing to board increases with respect to a destination of “for C”, the setting unit 23 may disperse the third taxi stand 200c whose destination is “for C” so as to set the two third taxi stands 200c. In a case where the number of persons wishing to board becomes extremely small with respect to a destination, the setting unit 23 may cancel the corresponding taxi stand 200.

Thus, the number of the taxi stands 200 can be set to an appropriate one in accordance with the number of persons wishing to board, so that it is possible to further efficiently ease congestion in the spot E that is a periphery of the facility 100.

The setting unit 23 may set the taxi stand 200 for each type of a taxi, in other words, each vehicle type of a taxi. For example, the setting unit 23 may set the taxi stand 200 of a compact vehicle and the taxi stand 200 of a large-sized vehicle. Specifically, in a case where the user information 32 (see FIG. 5) includes many pieces of information indicating that the number of passengers to board is comparatively large (in other words, information that indicates group of large headcount), a large-size vehicle is appropriate for a taxi to be used by the users, and thus the setting unit 23 sets the taxi stand 200 of a large-sized vehicle. In FIG. 6, the example is indicated in which the taxi stand 200 of the vehicle type M1 and the taxi stand 200 of a vehicle type M2 are set for the taxi stands 200 whose destination is “for B”.

Thus, the number of the taxi stands 200 can be set to the appropriate one according to the number of persons wishing to board (in other words, headcount of group), so that it is possible to further efficiently ease congestion in the spot E that is a periphery of the facility 100.

The setting unit 23 may set the taxi stand 200 according to presence/absence of a reservation for a taxi. For example, on the basis of the user information 32 (see FIG. 5), the setting unit 23 may set the taxi stand 200 to be used by a person (user) alone having made a reservation for a taxi, and the taxi stand 200 to be used by a person (user) alone not having made a reservation for a taxi. In this case, the setting unit 23 may preferentially allow dispatch for the taxi stand 200 to be used by a person alone having made a reservation. In FIG. 6, the example is indicated in which the taxi stands 200 are set for the taxi stands 200 having a destination of “for A” depending on presence/absence of a reservation.

As described above, presence/absence of a reservation is set as a condition for using a taxi of the taxi stand 200, and a taxi is preferentially dispatched to the taxi stand 200 that is used by a person having made a reservation, so that it is possible to urge a user to make a reservation by using an application, for example.

The setting unit 23 may read out the road information 35 of the storage 30 so as to set a route of a taxi for the taxi stand 200 on the basis of the read road information 35. In the example illustrated in FIG. 8, in a case where the road information 35 includes information indicating the fact that a road of a route Rc is not congested and roads of routes Rd1 and Rd2 are congested, the setting unit 23 sets the route Rc as a route for the taxi stand 200. The setting unit 23 transmits, to a taxi, a dispatch instruction including information on the route Rc. Thus, a taxi goes for the taxi stand 200 via the route Rc. In the above-mentioned, congestion information of the road information 35 is used for setting a route of a taxi; however, not limited thereto, for example, other information such as estimated congestion information and construction information may be used.

As described above, a route of a taxi for the taxi stand 200 is set on the basis of the road information 35, so that it is possible to facilitate movement of a taxi for the taxi stand 200. Thus, a taxi early arrives at the taxi stand 200, persons are hardly retained in the taxi stand 200, so that it is possible to further efficiently ease congestion in the spot E that is a periphery of the facility 100.

Continuing explanation of FIG. 3, the display controlling unit 24 is capable of controlling displaying of the display 70 (see FIG. 2). For example, in a case where a position where the display 70 is arranged is set as the taxi stand 200 by the setting unit 23, the display controlling unit 24 causes the display 70 to display information related to a taxi corresponding to the above-mentioned taxi stand 200.

Herein, the display 70 will be explained with reference to FIG. 9. FIG. 9 is a diagram illustrating the display 70 according to the first embodiment. As illustrated in FIG. 9, the display 70 includes a display screen 71 that is capable of displaying various kinds of information. The display 70 is arranged in a predetermined position of a candidate stand in a periphery of the facility 100, for example.

In a case where a position of a candidate stand where the display 70 is arranged is set as the taxi stand 200, the display controlling unit 24 delivers, to the display 70, information related to a taxi corresponding to the taxi stand 200 via the communication network N (see FIG. 2). Thus, the display screen 71 of the display 70 displays information related to a taxi of the taxi stand 200.

In FIG. 9, the example is indicated in which information related to a taxi is a destination of a taxi, a vehicle type of a taxi, a waiting time interval, and the like; however, these are merely examples, and not limited thereto. In other words, for example, the information related to a taxi may be other information such as presence/absence of a reservation as a condition for using a taxi and a stand-by number of a taxi.

As described above, in the taxi stand 200, the display 70 whose displaying is controlled by the display controlling unit 24 is arranged, and a person retained in a periphery of the facility 100 is able to easily recognize a position that is set as the taxi stand 200, and further to smoothly move to the above-mentioned taxi stand 200. Thus, it is possible to further effectively ease a peripheral congestion of the facility 100.

In a case where a position (in other words, position of candidate stand) where the display 70 is arranged is not set as the taxi stand 200, the display controlling unit 24 may not display information related to a taxi.

The display 70 may be a fixed type that is preliminary fixed in the above-mentioned position of the candidate stand or a moving type that is moved and arranged in the position of the candidate stand or the set taxi stand 200 at an appropriate timing. In FIG. 9, the display 70 having a standing type is indicated as one example, not limited thereto, may be a wall-mounted type, a hanging type, or the like.

<Control Process of Information Processing Device According to First Embodiment>

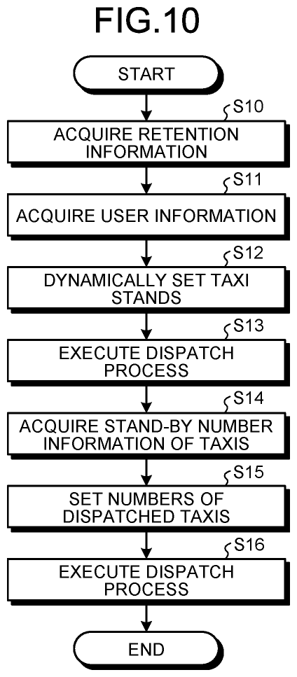

Next, one example of a specific processing procedure of the information processing device 10 according to the first embodiment will be explained with reference to FIG. 10. FIG. 10 is a flowchart illustrating a processing procedure to be executed by the information processing device 10 according to the first embodiment.

As illustrated in FIG. 10, the control unit 20 of the information processing device 10 acquires retention information in the facility 100 (Step S10). Next, the control unit 20 acquires user information including information on a destination of a user and the like (Step S11).

Next, on the basis of retention information, user information, and the like; the control unit 20 dynamically sets the plurality of taxi stands 200 (Step S12). Subsequently, the control unit 20 executes a dispatch process for informing the on-vehicle device 50 provided in a taxi of position information on the set taxi stand 200 and the like (Step S13).

Next, the control unit 20 acquires stand-by number information that indicates the number of taxis that stand by in each of the plurality of set taxi stands 200 (Step S14). Next, on the basis of the stand-by number information, the control unit 20 sets the numbers of taxis to be dispatched to the taxi stands 200 so as to equalize the numbers of taxis that stand by in the plurality of taxi stands 200 (Step S15). Next, the control unit 20 executes a dispatch process such that the set number of taxis go to the taxi stands 200 (Step S16).

As described above, the information processing device 10 according to the first embodiment includes the acquisition unit 22 and the setting unit 23. The acquisition unit 22 acquires retention information indicating a retention situation of persons in the event facility 100. The setting unit 23 dynamically sets a plurality of stands (taxi stands 200) of taxis (one example of moving bodies) based on the retention information acquired by the acquisition unit 22.

The acquisition unit 22 acquires stand-by number information that indicates numbers of taxis standing by in the plurality of taxi stands 200 set by the setting unit 23. Based on the stand-by number information acquired by the acquisition unit 22, the setting unit 23 sets the numbers of moving bodies to be dispatched to the taxi stands 200 such that the numbers of taxis standing by in the plurality of taxi stands 200 are equalized. Thus, it is possible to efficiently ease peripheral congestion in the event facility 100.

The moving body is a taxi. Thus, it is possible to smoothly disperse persons retained in a periphery of the facility 100 into the taxi stands 200, so that it is further possible to efficiently ease a peripheral congestion of the facility 100.

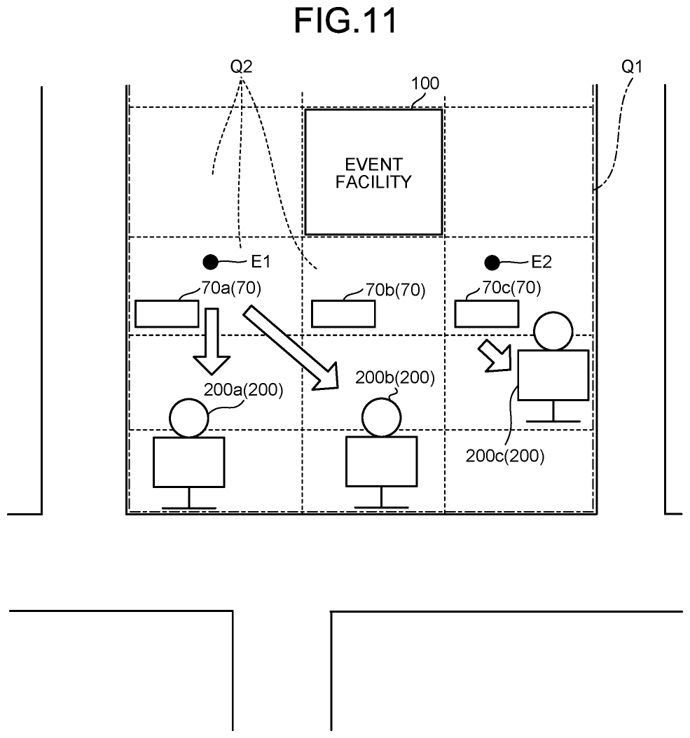

(Modification) Next, the information processing device 10 according to a modification will be explained. FIG. 11 is a diagram illustrating the information processing device 10 according to the modification.

As illustrated in FIG. 11, in the modification, each of displays 70a to 70c (70) is arranged in the corresponding divided region Q2 in a position that is leadable to the taxi stand 200 from among the plurality of divided regions Q2. The above-mentioned display 70 displays information for guiding persons retained in the periphery of facility 100 to the taxi stands 200 (for example, information that indicates direction for taxi stand 200, distance up to the taxi stand 200, and the like).

For example, the display controlling unit 24 (see FIG. 3) causes the display 70 to display information for leading (guiding) to the appropriate taxi stand 200 for each of the divided regions Q2. Thus, in the modification, it is possible to efficiently ease a peripheral congestion of the facility 100.

Specifically, the plurality of displays 70 are set such that the leadable taxi stands 200 are different from each other. Herein, setting of the leadable taxi stand 200 may be on the basis of accessibility to the taxi stand 200 in addition to or instead of a congestion situation of the taxi stand 200, for example. The accessibility to the above-mentioned taxi stand 200 includes various factors that, for example, a movement distance of the taxi stand 200 is short, a smooth movement is possible (for example, movement route is broad and is hardly congested, or movement route does not intersect with movement route for other taxi stand 200), etc.

In the example illustrated in FIG. 11, on the basis of the above-mentioned accessibility and the like, the display controlling unit 24 is capable of causing the display 70a to display information leading to the first and the second taxi stands 200a and 200b. In other words, the display controlling unit 24 causes the display 70a not to display information leading to the third taxi stand 200c. Thus, as indicated by using open arrows, persons retained in the spot E1 in the divided region Q2 where the display 70a is arranged are guided to the first and the second taxi stands 200a and 200b, on the other hand, it is possible to reduce the number of persons moving to the third taxi stand 200c.

Similarly, the display controlling unit 24 causes the display 70c to display information leading to the third taxi stand 200c, and further not to display information leading to the first and the second taxi stands 200a and 200b. Thus, as indicated by using open arrows, persons retained in a spot E2 of the divided region Q2 where the display 70c is arranged move to the third taxi stand 200c, on the other hand, it is possible to reduce the number of persons moving to the first and the second taxi stands 200a and 200b.

Thus, persons retained in the spots E1 and E2 hardly intersect with each other when moving to the taxi stands 200 to be able to smoothly move to the taxi stands 200, so that it is possible to efficiently ease a peripheral congestion of the facility 100.

In the above-mentioned modification, guiding to the taxi stands 200 is executed via the display 70 that is arranged in the divided region Q2; however, not limited thereto. For example, on the basis of user position information obtained from the terminal device 40, the control unit 20 may detect a position of a user in each of the divided regions Q2, and may transmit, to the terminal device 40, information for guiding to the taxi stand 200 in accordance with the detected position of the user.

<Outline of Information Processing Method According to Second Embodiment>

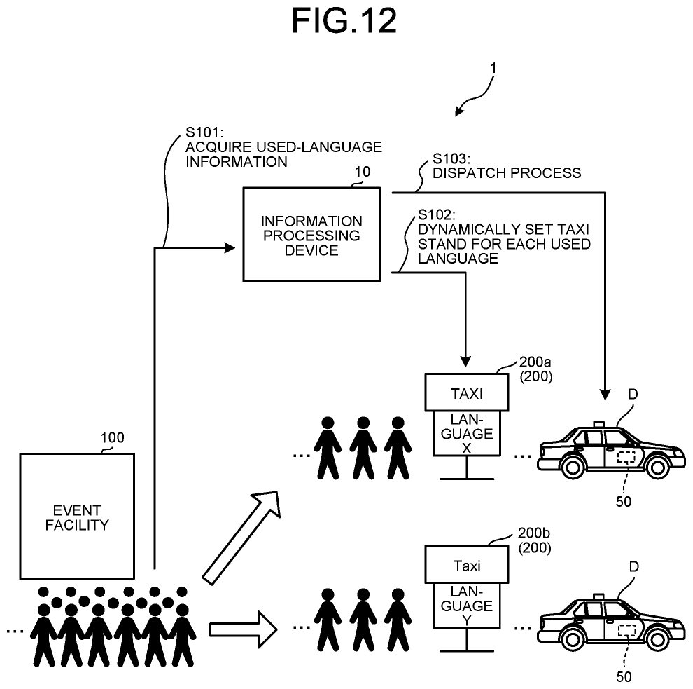

A second embodiment will be explained. When explaining the second embodiment, explanation of parts duplicated with the first embodiment will be appropriately simplified or omitted. First, the outline of an information processing method according to the second embodiment will be explained with reference to FIG. 12. FIG. 12 is a diagram illustrating the outline of an information processing method according to the second embodiment.

As illustrated in FIG. 12, in the facility 100, as described above, for example, when an event ends, when an event ends, users having used the facility 100, in other words, audiences exit at the same time. Thus, for example, in a stand of a taxi or a bus on the way home or in the nearest station, a long line is likely to be formed, and thus congestion easily occur in the periphery of facility 100.

Herein, for example, in a taxi stand and the like, if users are able to smoothly ride taxis and the like, a long line is hardly formed in the taxi stand and the like, so that it is possible to reduce occurrence of congestion in the periphery of facility 100.

However, for example, depending on a type of an event held in the facility 100 such as an international match of sports, the number of foreign persons is large among users that are audiences, so that used languages of the users become multiple in some cases. In this case, for example, communication between a user and a driver of a taxi or a bus requires a long time interval, and thus smooth riding on a taxi or the like is impossible in some cases. Thus, a long line is formed in a taxi stand or the like, as a result, there presents possibility that congestion occurs in the periphery of facility 100.

Thus, the information processing device 10 according to the second embodiment is configured to reduce occurrence of congestion in the periphery of facility 100 even in a case where used languages of users are multiple.

Hereinafter, processing of the information processing device 10 according to the second embodiment will be specifically explained, first, the information processing device 10 acquires used-language information that indicates a used language of a user that uses the facility 100 (Step S101). Herein, the used language is not limited to a language that is usually used by a user, and may include a language that can be used by the user or a language that can be comprehended by the user.

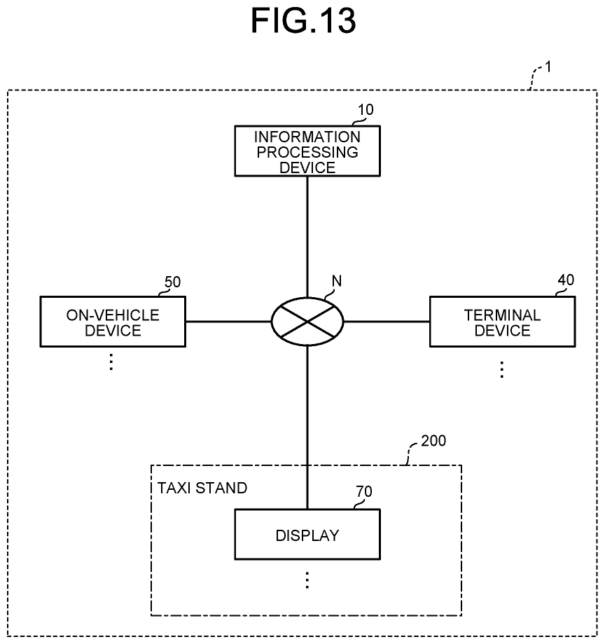

The information processing device 10 receives and acquires the above-mentioned used-language information from the terminal device 40 (see FIG. 13) carried by a user, for example; this point will be mentioned later.

Next, on the basis of the acquired used-language information, the information processing device 10 dynamically sets the stand 200 of the taxi D for each used language (Step S102).

Similar to the first embodiment, for example, when an event is not held in the facility 100 or before an event ends, a position where the above-mentioned taxi stand 200 is set to a position that is not a taxi stand in the periphery of facility 100, in other words, a position that does not function as a taxi stand. In other words, the taxi stand 200 is a stand that is virtually set in the periphery of facility 100, and is a stand that is newly set after an event ends, for example.

The example is illustrated in FIG. 12 in which the number of the taxi stands 200 is two; however, not limited thereto, the number may be one, or equal to or more than three. In FIG. 12, the example is indicated in which the first taxi stand 200a is set to a used language of “language X”, and the second taxi stand 200b is set to a used language “language Y”.

Note that in the above-mentioned, the taxi stands 200 are virtually set; however, not limited thereto. In other words, the information processing device 10 may change (turn) and set already-present taxi stands in the periphery of facility 100 to the taxi stand 200 for each used language.

Next, if the taxi stand 200 is set, the information processing device 10 executes a dispatch process of the taxis D (Step S103). For example, the information processing device 10 informs the on-vehicle device 50 provided in the taxi D of information related to the taxi stand 200.

Specifically, the information processing device 10 informs the on-vehicle device 50 provided in the taxi D of used-language information having been set for the taxi stand 200 (hereinafter, may be referred to as “set used-language information”), position information of the taxi stand 200, and the like. Therefore, for example, the taxi D is capable of supporting the set used language goes to the taxi stand 200, and thus the taxi D is capable of smoothly picking up a user at the taxi stand 200.

The information processing device 10 may transmit a dispatch instruction to the taxi D capable of supporting the set used language. Thus, it is possible to cause the taxi D capable of supporting the set used language to reliably go to the taxi stand 200, and thus a user is able to smoothly ride the taxi D at the taxi stand 200.

As described above, in the second embodiment, the taxi stand 200 is set for each used language. Thus, even in a case where used languages of users are multiple, if each user goes to the taxi stand 200 corresponding to his/her own used language, the user is able to smoothly ride the taxi D. Thus, a long line is hardly formed in the taxi stand 200, as a result, it is possible to reduce occurrence of congestion in the periphery of facility 100.

Note that in a case where a moving body is a bus, for example, the information processing device 10 sets a bus stand for each used language on the basis of used-language information.

<Configuration of Information Processing System According to Second Embodiment>

A configuration of the information processing system 1 including the information processing device 10 according to the second embodiment will be explained with reference to FIG. 13. FIG. 13 is a block diagram illustrating a configuration example of the information processing system 1 according to the second embodiment.

As illustrated in FIG. 13, the information processing system 1 includes the information processing device 10, the terminal device 40, the on-vehicle device 50, and the display 70.

The terminal device 40 is a device that is carried and used by a user (audience) of the facility 100. Similar to the first embodiment, the terminal device 40 is capable of executing a process for making a reservation of a taxi. For example, a destination and the like are input into the terminal device 40 by an operation of a user, and the terminal device 40 transmits the input destination and the like to the information processing device 10 as reservation information. In addition to or instead of a destination, the reservation information may include other information such as the number of passengers to board.

The terminal device 40 is capable of transmitting used-language information and/or nationality information of a user to the information processing device 10. In the terminal device 40, used-language information and/or nationality information of a user may be registered by a user him/herself, or may be preliminarily registered by the terminal device 40 and/or an application.

Herein, a user of the terminal device 40 is able to require a translator when using a taxi. For example, in a case where a user requires a translator, caused by an operation of a user, the terminal device 40 is capable of transmitting a translation request for requesting translation by a translator to the information processing device 10. The above-mentioned translator is a person that executes translation between a user and a driver of a taxi, for example.

In the second embodiment, among a plurality of users (audiences) of the facility 100, a user other than a user having required a translator is set as a translator, this point will be mentioned later.

As described above, the on-vehicle device 50 is provided in a taxi, and is capable of transmitting, to the information processing device 10, supported language information that indicates a language which a driver of a taxi is able to support. In the on-vehicle device 50, the supported language information may be registered by a driver, or may be registered by a management server (not illustrated) that manages taxis.

The on-vehicle device 50 is capable of receiving a dispatch instruction that is transmitted from the information processing device 10. In a case where the on-vehicle device 50 receives the dispatch instruction, a taxi moves to the taxi stand 200 for which a supportable used language is set, and picks up a passenger (user) in the taxi stand 200.

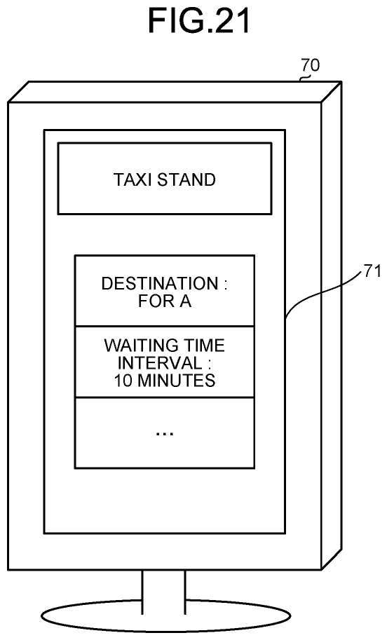

The display 70 is configured to be arranged in the taxi stand 200, and displays information related to the taxi stand 200 such as a destination. Note that the display 70 will be mentioned later with reference to FIG. 21.

<Configuration of Information Processing Device According to Second Embodiment>

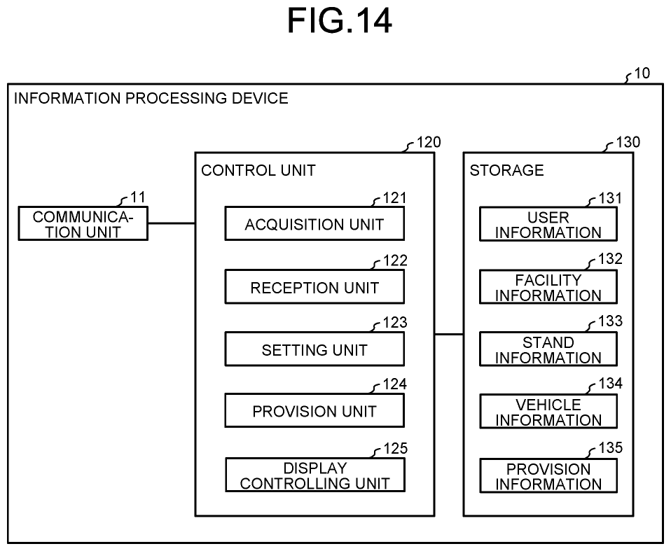

Details of a configuration of the information processing device 10 according to the second embodiment will be specifically explained with reference to FIG. 14 and the like. FIG. 14 is a block diagram illustrating a configuration example of the information processing device 10 according to the second embodiment.

As illustrated in FIG. 14, the information processing device 10 includes the communication unit 11, a control unit 120, and a storage 130. The communication unit 11 is similar to the one according to the first embodiment.

The control unit 120 includes an acquisition unit 121, a reception unit 122, a setting unit 123, a provision unit 124, and a display controlling unit 125, and includes a computer including, for example, a CPU, a ROM, a RAM, a hard disc drive, an input/output port, and the like; and various circuits.

The CPU of the computer reads out and executes a program stored in the ROM, for example, so as to function as the acquisition unit 121, the reception unit 122, the setting unit 123, the provision unit 124, and the display controlling unit 125 of the control unit 120. At least a part or all of the acquisition unit 121, the reception unit 122, the setting unit 123, the provision unit 124, and the display controlling unit 125 of the control unit 120 may be constituted of hardware such as an ASIC and an FPGA.

The storage 130 is a storage constituted of a storage device such as a non-volatile memory, a data flash, and a hard disc drive. The above-mentioned storage 130 stores therein user information 131, facility information 132, stand information 133, vehicle information 134, provision information 135, various programs, and the like.

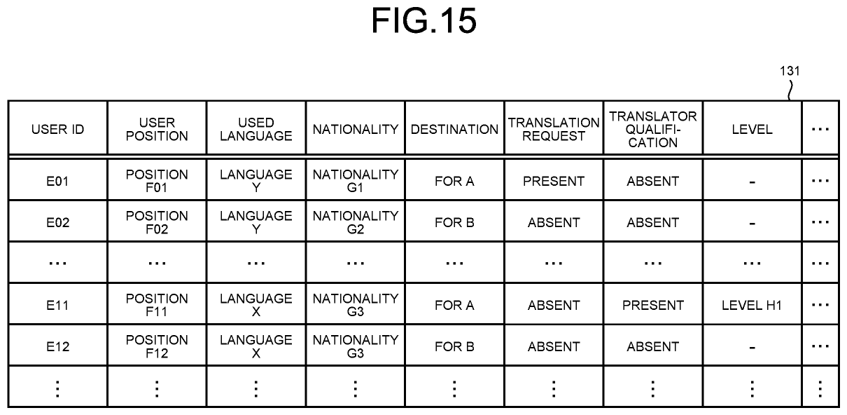

The user information 131 is information related to a user that uses the facility 100. The user information 131 will be explained with reference to FIG. 15. FIG. 15 is a diagram illustrating one example of the user information 131 according to the second embodiment.

As illustrated in FIG. 15, the user information 131 includes items such as “user ID”, “user position”, “used language”, “nationality”, “destination”, “translation request”, “translator qualification”, and “level”; and the items are associated with each other.

The “user ID” is identification information that identifies a user. The “user position” is user position information that indicates a position of a user. In the example illustrated in FIG. 15, for convenience of explanation, “user position” may be abstractly referred to as “position F01”, and the “position F01” stores therein specific information. Hereinafter, other pieces of information may be also abstractly referred.

The “used language” is used-language information that indicates a used language of a user. The “nationality” is nationality information that indicates a nationality of a user.

The “destination” is information that indicates a destination of a user from the facility 100. For example, the “destination” is information that indicates a destination of a user after an event ends in the facility 100. Specifically, information on a destination, which is included in reservation information transmitted from the terminal device 40, is registered in the “destination”.

In a case where reservation information does not include information on a destination, or in a case where there presents no reservation, a destination may be estimated from other information, and information on the estimated destination may be registered in “destination”. In other words, for example, when an event ends, a user often returns to his/her home via a route reverse to a route to the facility 100, or often returns to his/her home from the facility 100. Thus, for example, the acquisition unit 121 (see FIG. 14) of the control unit 120 acquires behavior history information (specifically, information on route to facility 100), home information of a user, and the like from the terminal device 40, and estimates a destination of the user after an event ends on the basis of the above-mentioned behavior history information, the above-mentioned home information, and the like. The acquisition unit 121 is capable of registering information on the estimated destination as “destination” of the user information 131.

The “translation request” is information that indicates presence/absence of a translation request that requests translation by a translator. The “translator qualification” is information that indicates presence/absence a credential for the above-mentioned translator. For example, in a case where an institution related to language, such as an institution conducting the evaluation of language, identifies that a user has a credential for a translator, information on the above-mentioned credential is registered by a management server (not illustrated) of the above-mentioned institution; however, not limited thereto. In other words, for example, the information processing device 10 may register the credential by another method, for example, in a case where a user submits thereto information certifying presence of a credential for a translator, the information processing device 10 may identify presence of a credential for a translator so as to register the credential.

The “level” is information that indicates a language level of a user identified to have a credential for a translator. The language level is an index value that indicates a value of an extent of capability related to translation of a translator by using several-step levels. The language level is also registered by a management server of an institution related to language; however, not limited thereto.

In the example illustrated in FIG. 15, data on a user that is identified by a user ID “E01” indicates that a user position is “position F01”, a used language is “language Y”, a nationality is “nationality G1”, a destination is “for A”, a translation request is “present”, and a translator qualification is “absence”. Data on a user that is identified by a user ID “Ell” indicates that a user position is “position F11”, a used language is “language X”, a nationality is “nationality G3”, a destination is “for A”, a translation request is “absence”, a translator qualification is “present”, and a level is “level H1”.

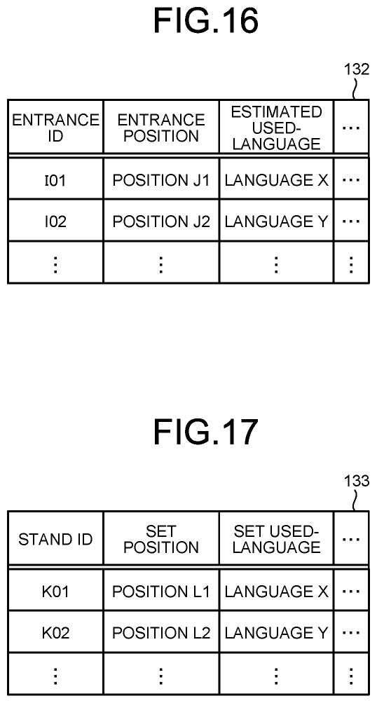

Returning to FIG. 14, the facility information 132 is information related to the facility 100, and specifically is information related to an entrance used by a user in the facility 100. Herein, with reference to FIG. 16, the facility information 132 according to the second embodiment will be explained. FIG. 16 is a diagram illustrating one example of the facility information 132 according to the second embodiment.

As illustrated in FIG. 16, the facility information 132 includes “entrance ID”, “entrance position”, “estimated used-language”, and the like, and the items are associated with each other.

The “entrance ID” is identification information that identifies an entrance of the facility 100 (for example, east exit, west exit, and the like). The “entrance position” is position information that indicates a position of an entrance of the facility 100.

The “estimated used-language” is information related to a used language of a user, which is estimated to be used in a corresponding entrance. For example, explaining the above-mentioned, in a case where an event held in the facility 100 is an international match of sports or the like, in the facility 100, users (audiences) are divided for each team of a game such as a home side and an away side. Thus, when an event ends, users exit through an entrance in a group divided for each team, in other words, use an entrance.

The “estimated used-language” is information related to used languages used by a group of users that are estimated to use an entrance. Note that if a type and/or a content of an event in the facility 100 changes, information on the “estimated used-language” also changes. In the second embodiment, the taxi stand 200 supporting a set used-language that is the same as an estimated used-language is set to a position on a corresponding entrance side, this point will be mentioned later.

In the example illustrated in FIG. 16, data on an entrance of the facility 100, which is identified by an entrance ID “101”, indicates that an entrance position is “position J1” and an estimated used-language is “language X”.

Returning to FIG. 14, the stand information 133 is information related to the taxi stand 200. Herein, the stand information 133 will be explained with reference to FIG. 17. FIG. 17 is a diagram illustrating one example of the stand information 133 according to the second embodiment.

As illustrated in FIG. 17, the stand information 133 includes items such as “stand ID”, “set position”, and “set used-language”, and the like; and the items are associated with each other.

The “stand ID” is identification information that identifies the taxi stand 200. The “set position” is position information that indicates a set position of the taxi stand 200. The “set used-language” is information that indicates a used language set for the taxi stand 200.

The example illustrated in FIG. 17, data on the taxi stand 200 that is identified by the stand ID “K01” indicates that a set position is “the position L1”, and a set used-language is “language X”.

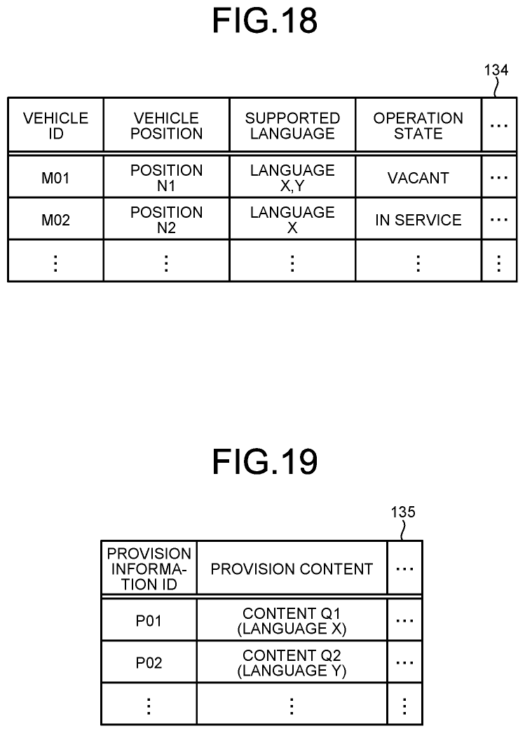

Returning to FIG. 14, the vehicle information 134 is information related to a taxi. Herein, the vehicle information 134 according to the second embodiment will be explained with reference to FIG. 18. FIG. 18 is a diagram illustrating one example of the vehicle information 134 according to the second embodiment.

As illustrated in FIG. 18, the vehicle information 134 includes items such as “vehicle ID”, “vehicle position”, “supported language”, and “operation state”, and the like; and the items are associated with each other.

The “vehicle ID” is identification information that identifies a taxi. The “vehicle position” is vehicle position information that indicates a position of a taxi. The “supported language” is information that indicates a language to be supported by a driver of a taxi. The “operation state” is operation-state information that indicates an operation state of a taxi.

In the example illustrated in FIG. 18, data on a taxi identified by a vehicle ID “M01” indicates that a vehicle position is “position N1”, supported languages are “languages X and Y”, and an operation state is “vacant”.

Returning to FIG. 14, the provision information 135 is information that is provided to a user. Herein, with reference to FIG. 19, the provision information 135 will be explained. FIG. 19 is a diagram illustrating one example of the provision information 135 according to the second embodiment.

As illustrated in FIG. 19, the provision information 135 includes items such as “provision information ID”, “provision content”, and the like; and the items are associated with each other.

The “provision information ID” is identification information that identifies provision information. The “provision content” is a content of information that is provided to a user using a taxi. The “provision content” is information on a content that is valuable for a user or a content interested by a user, such as information on a recommended restaurant, information on a sightseeing spot, and information on news; however, not limited thereto. The “provision content” is information using a used language of a user to which the information is provided.

In the example illustrated in FIG. 19, provision information that is identified by a provision information ID “P01” indicates that a provision content is “content Q1 (language X)”, in other words, “content Q1 using language X”.

Returning to FIG. 14. The acquisition unit 121 of the control unit 120 acquires various kinds of information via the communication unit 11. For example, the acquisition unit 121 acquires position information of a user from the terminal device 40, and registers the acquired information in the user information 131 (see FIG. 15) of the storage 130.

The acquisition unit 121 acquires used-language information that indicates a used language of a user, and nationality information of a user. For example, the acquisition unit 121 acquires used-language information and nationality information from the terminal device 40, and registers the acquired information in the user information 131 of the storage 130.

The acquisition unit 121 acquires facility information. Specifically, the acquisition unit 121 acquires facility information that includes position information on an entrance of the facility 100 and estimated used-language information related to a used language of a user estimated to use the above-mentioned entrance. For example, the acquisition unit 121 is capable of acquiring facility information from a facility managing server (not illustrated) that manages the facility 100 and an event held in the facility 100. Next, the acquisition unit 121 registers the acquired facility information in the facility information 132 (see FIG. 16) in the storage 130.

The acquisition unit 121 acquires vehicle position information, supported language information, operation-state information, and the like that are transmitted from the on-vehicle device 50, and further registers the acquired vehicle position information and the like in the vehicle information 134 (see FIG. 18) of the storage 130.

The acquisition unit 121 acquires provision information to be provided to a user that uses a taxi, and further stores the acquired information in the storage 130 as the provision information 135. The provision information is transmitted from an external server, for example; however, not limited thereto, may be preliminarily stored in the storage 130, for example.

The reception unit 122 receives reservation information of a taxi from the terminal device 40 via the communication unit 11, and further executes a process for receiving a reservation. For example, the reception unit 122 registers information, such as a destination included in reservation information, in the user information 131 (see FIG. 15). The reception unit 122 is capable of informing the terminal device 40 of a content indicating reception of a reservation.

In a case where a reservation process for a taxi is executed in the terminal device 40 via a taxi reservation site, the reception unit 122 may receive reservation information from an external device that delivers the taxi reservation site so as to execute a process for receiving a reservation.

The reception unit 122 is capable of receiving a translation request transmitted from the terminal device 40. In a case where receiving a translation request, the reception unit 122 registers information that indicates a reception of the translation request in the user information 131 (see FIG. 15).

In a case where receiving a translation request, the reception unit 122 executes a process for recruiting for a translator. For example, the reception unit 122 delivers information related to a translation request to the terminal device 40 of a user other than a user having executed the translation request so as to recruit a translator, and further informs the setting unit 123 of the information related to a translation request.

For example, information related to a translation request includes information such as a used language of a user having executed the translation request, a destination of a taxi to be used by a user, and a language level of a translator required by the user; however, these are merely examples, and not limited thereto. Note that the reception unit 122 may preliminarily execute a process for recruiting a translator before receiving a translation request.

The reception unit 122 is capable of receiving an application for the recruitment of a translator via the terminal device 40 from a plurality of users. Specifically, the reception unit 122 receives an application depending on a destination of a taxi. More specifically, the reception unit 122 receives an application depending on a destination of a taxi to be used by a user having executed a translation request.

In a case where receiving an application, the reception unit 122 reads out the user information 131 (see FIG. 15) of an applicant user from the storage 130, and further informs the setting unit 123 of the read information. The above-mentioned transmitted information includes information such as a destination, presence/absence of a translator qualification, and a language level of a language level; however, not limited thereto. Note that in the setting unit 123, determination of whether or not an applicant user satisfies a condition specified by a user having executed a translation request is executed, and this point will be mentioned later.

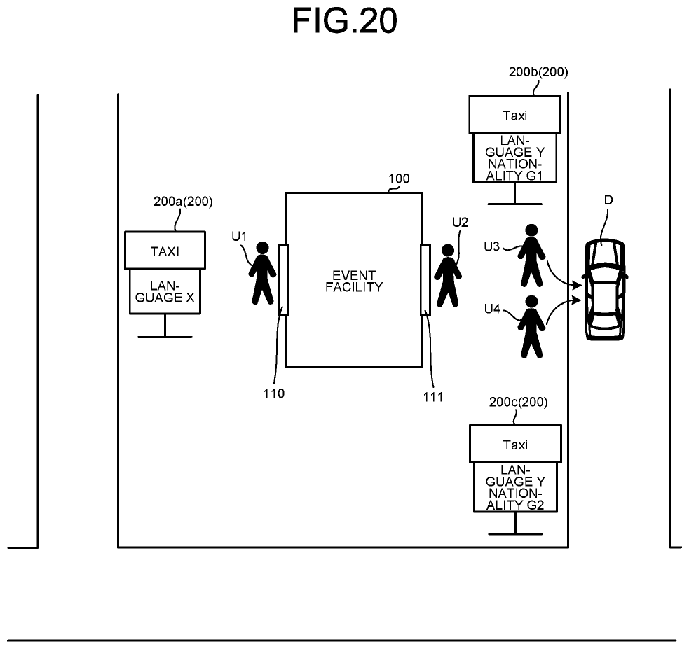

The setting unit 123 reads out used-language information of the user information 131 in the storage 130, and further dynamically sets the taxi stand 200 for each used language on the basis of the used-language information. In other words, the setting unit 123 sets the dynamic taxi stand 200 whose position and number are changed on the basis of used-language information. Herein, setting of the taxi stand 200 and the like will be explained with reference to FIG. 20. FIG. 20 is a diagram illustrating processes to be executed by the setting unit 123 according to the second embodiment.

As illustrated in FIG. 20, for example, in a case where used-language information of the user information 131 includes a user whose used language is the language X and a user whose used language is the language Y, the setting unit 123 dynamically sets the first taxi stand 200a whose set used-language is “language X” and the second and third the taxi stands 200b and 200c whose set used-languages are “language Y”.

For one example of setting of the taxi stand 200, on the basis of used-language information, the setting unit 123 is capable of selecting an appropriate number and a location of a position from among a plurality of positions of preliminarily-set candidate stands, and further setting a position of a selected candidate stand as the taxi stand 200. The setting unit 123 registers various kinds of information related to the taxi stand 200 such as a set position and a set used language of the taxi stand 200 in the stand information 133 (see FIG. 17) of the storage 130.

After setting the taxi stand 200, the setting unit 123 may execute a dispatch process for informing the on-vehicle device 50 provided in the taxi D of set used-language information and position information of the taxi stand 200 and the like. The setting unit 123 may read out the vehicle information 134 of the storage 130, and further may execute a dispatch process for transmitting a dispatch instruction that causes a taxi that is able to support a set used-language and whose operation state is vacant to go to the taxi stand 200. Thus, the taxi D capable of supporting the set used language goes to the taxi stand 200.

Thus, even in a case where used languages of users (audiences) of the facility 100 are multiple, if each user goes to the taxi stand 200 corresponding to his/her own used language, the user is able to easily communicate with a driver of a driver, and thus the user is able to smoothly ride the taxi D. Thus, a long line is hardly formed in the taxi stand 200, as a result, it is possible to reduce occurrence of congestion in the periphery of facility 100.

The setting unit 123 may set the taxi stand 200 in accordance with a headcount of users of each used language. For example, the setting unit 123 may set the number of the taxi stands 200 to an appropriate one by using a headcount of users of each used language.

Specifically, for example, the setting unit 123 measures a headcount of users for used language on the basis of the acquired used-language information. Next, the setting unit 123 may execute setting such that the number of the taxi stands 200 is increased or reduced in accordance with the measured headcount. More specifically, for example, the setting unit 123 may execute setting such that the number of the taxi stands 200 whose set used-language is “language X” is larger as a headcount of users whose used language is “language X” is larger.

As described above, the taxi stands 200 are set in accordance with a headcount of users for each used language, even in a case where the number of users whose used language is “language X”, for example, it is possible to disperse users waiting in line in the taxi stands 200. Thus, users are able to smoothly ride the taxis D, so that it is possible to effectively reduce occurrence of congestion in the periphery of facility 100.

On the contrary, in a case where a headcount of users whose used language is “language X” becomes extremely small, the setting unit 123 may abolish the taxi stand 200 whose set used-language is “language X”. In the example illustrated in FIG. 20, in a case where a headcount of users whose used language is “language X” becomes large, the setting unit 123 may divide (additionally arrange in other position to increase) the first taxi stand 200a into the plurality of first taxi stands 200a. In the example illustrated in FIG. 20, in a case where a headcount of users whose used language is “language Y” becomes small, the two second and the third taxi stands 200b and 200c may be integrated to obtain the one taxi stand 200. Moreover, in a case where a headcount of users whose used languages are “language X” and “the language Y” becomes small, for example, the three first, second, and third taxi stands 200a, 200b, and 200c may be integrated to obtain the one taxi stand 200, or the two first and the second taxi stands 200a and 200b alone are integrated to obtain the two taxi stands 200ab (language X and language Y) and 200c (language Y), namely the taxi stands may be integrated in accordance with situations. Thus, the number of the taxi stands 200 can be adjusted into an appropriate one according to the number of users that are going to use the taxis D, and thus the users are able to smoothly ride the taxis D, so that it is possible to effectively reduce occurrence of congestion in the periphery of facility 100.

In the above-mentioned, the number of the taxi stands 200 is set to an appropriate one by using a headcount of users for each used language; however, not limited thereto, for example, other information such as nationality information may be used.

For example, the setting unit 123 may set the taxi stand 200 on the basis of the acquired nationality information. In other words, for example, the setting unit 123 may divide the taxi stands 200 of each used language for each nationality so as to set the taxi stand 200. In the example illustrated in FIG. 20, the setting unit 123 divides the taxi stands 200 whose set used-language is “language Y” to set the second taxi stand 200b whose nationality is “nationality G1” and the third taxi stand 200c whose nationality is “nationality G2”.

Thus, for example, users waiting in line in the taxi stand 200 whose set used-language is “language Y” can be dispersed, and thus a long line is hardly formed in the taxi stand 200 whose set used-language is “language Y”, so that it is possible to effectively reduce occurrence of congestion in the periphery of facility 100.

In the above-mentioned, a headcount of users and/or a nationality for each used language is used; however, not limited thereto, the setting unit 123 may execute the division and set the taxi stand 200 in accordance with a destination, presence/absence of a reservation for a taxi, or the like.

The setting unit 123 may estimate a headcount of users that are going to use the taxi D on the basis of various kinds of information, and may set the taxi stand 200 in accordance with the estimated headcount (hereinafter, may be referred to as “estimated number of taxi users”).

For one example, the acquisition unit 121 acquires, form an external device, information on a past taxi usage rate in the facility 100 (for example, rate of user (taxi non-reserved person) having used taxi D without reservation for taxi with respect to users having used facility 100), the number of users of the day in the facility 100 which is obtained from a ticket sales number, or the like.

On the basis of information on the acquired taxi usage rate, the acquired number of users of the facility 100, and the like; the setting unit 123 estimates the number of taxi users without reservation of the day, adds thereto the actual number of persons with reservation so as to estimate the estimated number of taxi users. The setting unit 123 may estimate the above-mentioned estimated number of taxi users for each used language so as to dynamically set the taxi stand 200 of corresponding used language in accordance with the above-mentioned estimated number of taxi users. Thus, the number of the taxi stands 200 can be set to an appropriate one in consideration of the number of taxi users of estimated taxi non-reserved persons, and thus users are able to smoothly ride the taxis D, so that it is possible to effectively reduce occurrence of congestion in the periphery of facility 100.

The setting unit 123 may set a stand on the basis of acquired facility information. Thus, it is possible to further effectively reduce occurrence of congestion in the periphery of facility 100.

Specifically, as described above, facility information (see FIG. 16) includes estimated used-language information related to a used language of a user to be estimated to use an entrance of the facility 100. Herein, for one example, as illustrated in FIG. 20, assume that a used language of a user U1 estimated to use an entrance 110 of the facility 100 is “language X”, and a used language of a user U2 estimated to use an entrance 111 is “language Y”.

For example, the setting unit 123 sets the taxi stand 200 of a set used-language that is the same as an estimated used-language in a position on a corresponding entrance side. Specifically, the setting unit 123 sets the first taxi stand 200a whose set used-language is “language X” in a position on a side of the entrance 110, and further sets the second and the third taxi stands 200b and 200c whose set used-languages are “language Y” in a position on a side of the entrance 111.

Thus, for example, the user U1 in a group divided for each of teams playing a game and whose used language is “language X” is able to arrive at the first taxi stand 200a whose set used-language is “language X” just after passing through the entrance 110. Similarly, the user U2 in the group and whose used language is “language Y” is able to arrive at the second and the third taxi stands 200b and 200c whose set used-languages is “language Y” just after passing through the entrance 111.

Thus, users whose used language is “language X” and users used language is “language Y” are able to smoothly ride the taxis D, so that it is possible to further effectively reduce occurrence of congestion in the periphery of facility 100.

As described above, the setting unit 123 is capable of determining whether or not an applicant user of a translator satisfies a condition specified by a user having executed a translation request. For example, the setting unit 123 executes the determination on the basis of information related to a translation request transmitted from the reception unit 122 and user information on an applicant user of a translator.

For one example, in a case where a used language of a user having executed a translation request coincides with a credential of an applicant user of a translator, a destination of a taxi to be used by the user having executed the translation request coincides with a destination of the applicant user, and the applicant user satisfies a language level of a translator which is desired by the user having executed the translation request; the setting unit 123 sets the applicant user as a translator. The setting unit 123 sets the above-mentioned translator (see user U3 illustrated in FIG. 20) as a passenger that is able to ride together the taxi D to be used by the user having executed the translation request (see user U4 illustrated in FIG. 20). The above-mentioned condition for setting an applicant user as a translator is merely one example, and not limited thereto.

Thus, the user U4 having executed a translation request is able to further easily communicate with a driver of the taxi D by virtue of translation by a fellow-passenger translator (user U3), so that it is possible to smoothly ride the taxi D. Thus, a long line is hardly formed in the taxi stand 200, so that it is possible to effectively reduce occurrence of congestion in the periphery of facility 100.

In this case, the setting unit 123 may provide a benefit to the user U3 as a fellow-passenger translator. For example, the setting unit 123 may reduce a fare of the user U3 compared with a case where he/she commonly uses a taxi, in other words, a case where he/she does not rides a taxi as a translator. As described above, if a benefit is provided, it is possible to urge a user that uses the facility 100 to apply to a translator.

Furthermore, the setting unit 123 may change a fare in accordance with a language level of a translator. For example, the setting unit 123 may more reduce a fare as a language level of a translator is higher. Thus, for example, it is possible to further urge a user whose language level is comparatively high to apply to a translator. Moreover, a user whose language level is comparatively high rides a taxi together as a translator, so that a user having executed a translation request is able to further easily communicate with a driver of the taxi D and further to smoothly ride the taxi D.

Returning to FIG. 14, the provision unit 124 reads out the provision information 135 of the storage 130, and further provides information according to user used-language information to a user corresponding to the above-mentioned used-language information. For example, the provision unit 124 transmits and provides information according to user used-language information to the terminal device 40 of a user. The above-mentioned provision of information executed by the provision unit 124 is executed before a user rides a taxi, not limited thereto, may be executed after a user rides a taxi.

Thus, a user that is going to use a taxi is able to obtain information using a used language of him/herself (for example, information on content that is valuable for user or content interested by user, such as information on recommended restaurant).

The display controlling unit 125 is capable of controlling displaying of the display 70 (see FIG. 13). Herein, the display 70 will be explained with reference to FIG. 21. FIG. 21 is a diagram illustrating the display 70 according to the second embodiment. As illustrated in FIG. 21, on the display screen 71 of the display 70, information related to a taxi of the taxi stand 200 is displayed by displaying control executed by the display controlling unit 125.

For example, the display controlling unit 125 is capable of controlling the display 70 so as to prefer displaying in a used language that is assigned (set) to the display 70, the taxi stand 200 corresponding to the display 70, or the like. For example, the display controlling unit 125 may increase a time interval of displaying in an assigned used language or may cause the display 70 to execute displaying in both of an assigned used language and another language in a side-by-side manner such that displaying of the other language is subsequently changed into another different language (in other words, displaying in assigned used language is not changed). In a case of the above-mentioned configuration in which the other languages alone are changed, it is preferable that a preference order is set between languages to be changed. For example, a preference order of a language whose headcount rate is large in headcounts of users of used languages may be set to be high, or a preference order of an official language of a country in which the display 70 and the like are arranged (for example, in case where the display 70 and the like are arranged in Japan, official language is Japanese) may be set to be high.

In FIG. 21, the example is illustrated in which information related to a taxi includes a destination of a taxi, a waiting time interval, and the like, this is merely one example, and not limited thereto. In other words, for example, information related to a taxi may include other information such as a vehicle type of a taxi to be dispatched to the taxi stand 200 and a stand-by number of taxis in the taxi stand 200.

As described above, the display 70 whose displaying is controlled by the display controlling unit 125 is arranged in the taxi stand 200, and thus a user that is going to use a taxi is able to easily recognize a position that is set as the taxi stand 200, so that the user is able to smoothly move to the above-mentioned taxi stand 200.

<Control Process of Information Processing Device According to Second Embodiment>

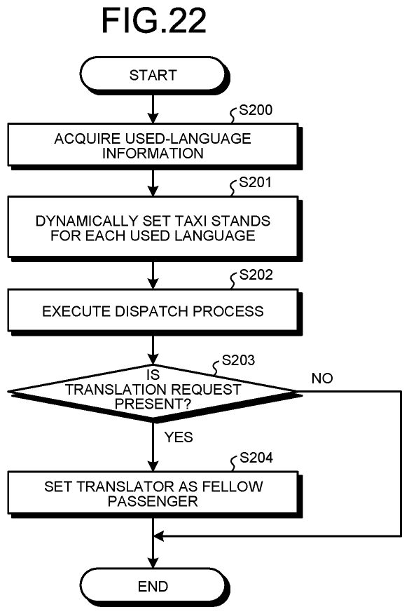

Next, one example of a specific processing procedure in the information processing device 10 according to the second embodiment will be explained with reference to FIG. 22. FIG. 22 is a flowchart illustrating a processing procedure to be executed by the information processing device 10 according to the second embodiment.

As illustrated in FIG. 22, the control unit 120 of the information processing device 10 acquires used-language information that indicates a used language of a user that uses the facility 100 (Step S200). Next, the control unit 120 dynamically sets the taxi stands 200 for each used language on the basis of the used-language information (Step S201).

Next, the control unit 120 executes a dispatch process for informing the on-vehicle device 50 provided in a taxi of used-language information and position information of the set taxi stand 200 and the like (Step S202).

Nest, the control unit 120 determines whether or not having received a translation request that requests translation by a translator (Step S203). In a case where determining that a translation request is received (Step S203: Yes), the control unit 120 receives an application of a translator from among other users that are different from the user having executed the translation request so as to set a translator, and set the above-mentioned translator as a passenger that is able to ride together a taxi used by the user having executed the translation request (Step S204).

On the other hand, in a case where determining that a translation request is not received (Step S203: No), the control unit 120 skips the process of Step S204 so as to end the processing.

As described above, the information processing device 10 according to the second embodiment includes the acquisition unit 121 and the setting unit 123. The acquisition unit 121 acquires used-language information that indicates used languages of users that use the event facility 100. The setting unit 123 dynamically sets stands (taxi stands 200) of taxis (one example of moving bodies) for each of the used languages based on the used-language information acquired by the acquisition unit 121. Thus, it is possible to reduce occurrence of congestion in a periphery of the event facility 100.

The moving body is a taxi. Thus, it is possible to cause a user in the periphery of facility 100 to move to the taxi stand 200 and to smoothly ride a taxi, so that it is further possible to reduce occurrence of congestion in the periphery of facility 100.

Any of the above-mentioned information processing systems 1 according to the first and the second embodiments and the modification may be configured not to include the display 70. In other words, for example, as long as the information processing device 10 informs a user of used-language information and position information of the set taxi stand 200 and the like (precisely, transmitting to terminal device 40 of user, for example), the user is able to go to the taxi stand 200, and thus the information processing system 1 may be configured not to include the display 70.

As described above, when transmitting information related to the taxi stand 200 to the terminal device 40, the information processing device 10 according to the second embodiment may transmit only information on the taxi stand 200 supporting a used language of a user that owns the above-mentioned terminal device 40. For example, in a case where a plurality of pieces of user used-language information are registered in the terminal device 40, the information processing device 10 may transmit information on the taxi stand 200 supporting each of a plurality of used languages to the above-mentioned terminal device 40.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### REFERENCE SIGNS LIST

10 Information processing device
20, 120 Control unit
21, 122 Reception unit
22, 121 Acquisition unit
23, 123 Setting unit
24, 125 Display controlling unit
100 Event facility
124 Provision unit
200 Taxi stand

1. An information processing device comprising:
a processor programmed to:
acquire retention information indicating a retention situation of persons in an event facility; and
set a plurality of stands of moving bodies based on the acquired retention information, wherein
the processor is further programmed to:
acquire stand-by number information that indicates numbers of moving bodies standing by in the plurality of set strands, and
based on the acquired stand-by number information, set the numbers of moving bodies to be dispatched to the stands such that the numbers of moving bodies standing by in the plurality of stands are equalized, wherein
the processor is further programmed to:
acquire the retention information for each divided region obtained by dividing a region including a periphery of the event facility to set divided regions, and
execute at least one of setting of the stands and setting of the moving bodies in accordance with the retention information in each of the acquired divided regions.

2. (canceled)

3. The information processing device according to claim 1, wherein
the processor is further programmed to:
acquire road information related to roads in a periphery of the event facility, and
based on the acquired road information, set routes of the moving bodies that go to the stands.

4. The information processing device according to claim 1, wherein
the processor is further programmed to:
cause, in a case where a position where a display is arranged is set as a stand, the display to display information related to the moving body corresponding to the stand.

5. An information processing device comprising:
a processor programmed to:
acquire used-language information that indicates used languages of users that use an event facility; and
dynamically set stands of moving bodies for each of the used languages based on the acquired used-language information, wherein
the processor is further programmed to:
acquire facility information that includes position information on an entrance of the event facility and estimated used-language information related to used languages of the users to be estimated to use the entrance, and
set the stands based on the acquired facility information.

6. The information processing device according to claim 5, wherein
the processor is further programmed to:
set the stands in accordance with a headcount of the users for each of the used languages.

7. The information processing device according to claim 5, wherein
the processor is further programmed to:
acquire nationality information that indicates nationalities of the users, and
set the stands based on the nationality information.

8. (canceled)

9. The information processing device according to claim 5, wherein
the processor is further programmed to:
receive an application for recruitment of a translator that performs translation with respect to a driver of a moving body from the plurality of users for each of destinations of the moving bodies; and
set the received translator as a passenger that is able to ride together the moving body.

10. An information processing method comprising:
acquiring retention information indicating a retention situation of persons in an event facility; and
dynamically setting a plurality of stands of moving bodies based on the retention information acquired in the acquiring, wherein
the acquiring includes acquiring stand-by number information that indicates numbers of moving bodies standing by in the plurality of stands set in the setting, and
based on the stand-by number information acquired in the acquiring, the setting includes setting the numbers of moving bodies to be dispatched to the stands such that the numbers of moving bodies standing by in the plurality of stands are equalized, wherein
the information processing method further comprises:
acquiring the retention information for each divided region obtained by dividing a region including a periphery of the event facility to set divided regions, and
executing at least one of setting of the stands and setting of the moving bodies in accordance with the retention information in each of the acquired divided regions.

11. (canceled)
